(19) United States
(12) Patent Application Publication
(10) Pub. No.: US 2026/0006457 A1
(43) Pub. Date: Jan. 1, 2026

(54) DIGITAL TWIN ENABLERS FOR OPEN RADIO ACCESS NETWORKS

(71) Applicant: QUALCOMM Incorporated, San Diego, CA (US)

(72) Inventors: Rajeev KUMAR, Bangalore (IN); Geetha Priya RAJENDRAN, Bangalore (IN); Rajat PRAKASH, San Diego, CA (US)

(21) Appl. No.: 18/757,251

(22) Filed: Jun. 27, 2024

(51) Int. Cl. H04W 16/22; H04W 16/18; H04W 24/06

(52) U.S. Cl. CPC H04W 16/22; H04W 16/18; H04W 24/06

(57) ABSTRACT

A digital twin of a wireless network comprises a registry storing services supported by digital twin functions; a 3D model management function for selecting a model; a network topology model management function for selecting a site and hardware; and a UE profile model management function for selecting user device distribution and mobility, and traffic profiles. The digital twin also includes a radio model management function for selecting and generating a radio model; a network and UE model management function for providing network behavior models and UE behavior models for running simulations; and a configuration model management function for selecting and creating network configurations and UE configurations for multiple modules. The digital twin further includes a simulation services module for simulating network and UE behavior; and a simulation orchestrator function for planning, analyzing, and optimizing network features and scenarios.

### FIELD OF THE DISCLOSURE

The present disclosure relates generally to wireless communications, and more specifically to digital twin enablers for open radio access networks (O-RANs).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

According to aspects of the present disclosure, a method for implementing a digital twin of a wireless network, includes storing, via a registry function, services supported by digital twin functions. The method also includes selecting, via a three dimensional (3D) model management function, a 3D model. The method further includes selecting, via a network topology model management function, a cellular site and associated hardware. The method still further includes selecting, via a user equipment (UE) profile model management function, user device distribution and mobility, and traffic profiles. The method still further includes selecting and generating, via a radio model management function, a radio channel model. The method additionally includes providing, via a network and UE model management function, network functional behavior models and UE functional behavior models for running simulations. The method also includes selecting and creating, via a configuration model management function, network configurations and UE configurations for multiple protocol modules. The method still further includes simulating, via a simulation services module, network functional behavior and UE functional behavior. The method also includes planning, analyzing, and optimizing, via a simulation orchestrator function, network features and scenarios.

Other aspects of the present disclosure are directed to an apparatus including a digital twin of a wireless network, the digital twin including a registry function configured to store services supported by digital twin functions. The digital twin also includes a three-dimensional (3D) model management function configured to provide services for selecting a 3D model. The digital twin further includes a network topology model management function configured to provide services for selecting a cellular site and associated hardware. The digital twin still further includes a user equipment (UE) profile model management function configured to provide services for selecting user device distribution and mobility, and traffic profiles. The digital twin additionally includes a radio model management function configured to provide services for selecting and generating a radio channel model. The digital twin also includes a network and UE model management function configured to provide network functional behavior models and UE functional behavior models for running simulations. The digital twin still further includes a configuration model management function configured to provide services for selecting and creating network configurations and UE configurations for multiple protocol modules. The digital twin also includes a simulation services module configured to provide services for simulating network functional behavior and UE functional behavior. The digital twin additionally includes a simulation orchestrator function configured to provide services for planning, analyzing, and optimizing network features and scenarios.

In still other aspects of the present disclosure, a non-transitory computer-readable medium with program code recorded thereon for implementing a digital twin of a wireless network is disclosed. The program code is executed by at least one processor and includes program code to store, via a registry function, services supported by digital twin functions. The program code also includes program code to select, via a three dimensional (3D) model management function, a 3D model. The program code further includes program code to select, via a network topology model management function, a cellular site and associated hardware. The program code also includes program code to select, via a user equipment (UE) profile model management function, user device distribution and mobility, and traffic profiles. The program code still further includes program code to select and generate, via a radio model management function, a radio channel model. The program code additionally includes program code to provide, via a network and UE model management function, network functional behavior models and UE functional behavior models for running simulations. The program code also includes program code to select and create, via a configuration model management function, network configurations and UE configurations for multiple protocol modules. The program code further includes program code to simulate, via a simulation services module, network functional behavior and UE functional behavior. The program code still further includes program code to plan, analyze, and optimize, via a simulation orchestrator function, network features and scenarios.

Other aspects of the present disclosure are directed to an apparatus. The apparatus includes means for storing services supported by digital twin functions. The apparatus also includes means for selecting a 3D model. The apparatus further includes means for selecting a cellular site and associated hardware. The apparatus still further includes means for selecting user device distribution and mobility, and traffic profiles. The apparatus additionally includes means for selecting and generating a radio channel model. The apparatus also includes means for providing network functional behavior models and UE functional behavior models for running simulations. The apparatus further includes means for selecting and creating network configurations and UE configurations for multiple protocol modules. The apparatus also includes means for simulating network functional behavior and UE functional behavior. The apparatus further includes means for planning, analyzing, and optimizing network features and scenarios.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 illustrates an overview of digital twin as a service (DTaaS), in accordance with various aspects of the present disclosure.

FIG. 5 illustrates a DTaaS registry component, in accordance with various aspects of the present disclosure.

FIG. 6 illustrates a DTaaS three-dimensional (3D) model management component, in accordance with various aspects of the present disclosure.

FIG. 7 illustrates a DTaaS radio model management component, in accordance with various aspects of the present disclosure.

FIG. 8 illustrates a DTaaS network and UE model management component, in accordance with various aspects of the present disclosure.

FIG. 9 illustrates a DTaaS simulation services (SS) component, in accordance with various aspects of the present disclosure.

FIG. 10 illustrates a DTaaS configuration model management component, in accordance with various aspects of the present disclosure.

FIG. 11 illustrates a DTaaS network topology management component, in accordance with various aspects of the present disclosure.

FIG. 12 illustrates a DTaaS UE profile management component, in accordance with various aspects of the present disclosure.

FIG. 13 illustrates a DTaaS simulation orchestrator component, in accordance with various aspects of the present disclosure.

FIG. 14 illustrates a baseline open radio access network (O-RAN) service management and orchestration (SMO) architecture, in accordance with various aspects of the present disclosure.

FIGS. 15A and 15B illustrate a DTaaS foundation architecture implementation, in accordance with various aspects of the present disclosure.

FIGS. 16A and 16B illustrate a DTaaS foundation architecture implementation, in accordance with various aspects of the present disclosure.

FIGS. 17A and 17B illustrate a DTaaS third-party foundation architecture implementation, in accordance with various aspects of the present disclosure.

FIGS. 18A and 18B illustrate a DTaaS foundation and orchestrator architecture implementation, in accordance with various aspects of the present disclosure.

FIGS. 19A and 19B illustrate a DTaaS non-real-time radio access network intelligent controller application (rApp) architecture implementation, in accordance with various aspects of the present disclosure.

FIG. 20 illustrates a DTaaS architecture with an intent manager component, in accordance with various aspects of the present disclosure.

FIG. 21 is a timing diagram illustrating a first portion of a recipe for coverage improvement, in accordance with various aspects of the present disclosure.

FIG. 22 is a timing diagram illustrating a second portion of the recipe for coverage improvement, in accordance with various aspects of the present disclosure.

FIG. 23 is a timing diagram illustrating a third portion of the recipe for coverage improvement, in accordance with various aspects of the present disclosure.

FIG. 24 is a timing diagram illustrating a first portion of a recipe for energy saving, in accordance with various aspects of the present disclosure.

FIG. 25 is a timing diagram illustrating a second portion of the recipe for energy saving, in accordance with various aspects of the present disclosure.

FIG. 26 is a timing diagram illustrating a third portion of the recipe for energy saving, in accordance with various aspects of the present disclosure.

FIG. 27 is a timing diagram illustrating a 3D model retrieval technique, in accordance with various aspects of the present disclosure.

FIG. 28 is a timing diagram illustrating a technique for generating a radio model, in accordance with various aspects of the present disclosure.

FIG. 29 is a timing diagram illustrating a technique for retrieving a network or UE behavior model, in accordance with various aspects of the present disclosure.

FIG. 30 is a timing diagram illustrating a technique for running a simulation, in accordance with various aspects of the present disclosure.

FIG. 31 is a timing diagram illustrating a network configuration change monitoring technique, in accordance with various aspects of the present disclosure.

FIG. 32 is a timing diagram illustrating an active network configuration model retrieval technique, in accordance with various aspects of the present disclosure.

FIG. 33 is a timing diagram illustrating a network or UE configuration model addition technique, in accordance with various aspects of the present disclosure.

FIG. 34 is a timing diagram illustrating a network or UE configuration model retrieval technique, in accordance with various aspects of the present disclosure.

FIG. 35 is a timing diagram illustrating a transmit/receive unit (TRU) information addition technique, in accordance with various aspects of the present disclosure.

FIG. 36 is a timing diagram illustrating a TRU information update technique, in accordance with various aspects of the present disclosure.

FIG. 37 is a timing diagram illustrating a TRU layout model generation technique, in accordance with various aspects of the present disclosure.

FIG. 38 is a timing diagram illustrating a TRU layout model retrieval technique, in accordance with various aspects of the present disclosure.

FIG. 39 is a timing diagram illustrating a UE location and mobility information addition technique, in accordance with various aspects of the present disclosure.

FIG. 40 is a timing diagram illustrating a UE layout model retrieval technique, in accordance with various aspects of the present disclosure.

FIG. 41 is a timing diagram illustrating a UE layout model generation technique, in accordance with various aspects of the present disclosure.

FIG. 42 is a timing diagram illustrating an active UE location model retrieval technique, in accordance with various aspects of the present disclosure.

FIG. 43 is a timing diagram illustrating a service registration and activation technique, in accordance with various aspects of the present disclosure.

FIG. 44 is a timing diagram illustrating a repository access technique, in accordance with various aspects of the present disclosure.

FIG. 45 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Digital twins are virtual replicas or simulations of physical radio access network (RAN) infrastructure components such as base stations, antennas, and network elements. Digital twins are generated via modeling and simulation techniques that perform real-time data and analytics to accurately reflect the behavior and performance of their physical counterparts. By implementing digital twins, network operators can gain insights into RAN operations, predict network behavior, and improve performance. Digital twins also enable network operators to perform proactive maintenance, troubleshoot issues, and experiment with network configurations without disrupting live services. Additionally, digital twins support the development and testing of new technologies and services.

Creating digital twins, while useful for various industries including telecommunications, presents several challenges. First, as a relatively new concept, the methodologies and standards for digital twin creation are still undefined, leading to a lack of clear guidelines and best practices. Improving accuracy and reliability in modeling real-world RAN infrastructure presents significant technical hurdles that specify complicated processes and data integration techniques. Additionally, the large amount of data implemented for digital twin creation, including network configurations, performance metrics, and environmental variables, may overload existing computational resources and data management systems. Furthermore, maintaining synchronization between the digital twin and its physical counterpart in real-time introduces latency and synchronization challenges that impact the effectiveness of predictive analytics and proactive maintenance strategies.

Aspects of the present disclosure are directed to digital twin enablers for open radio access networks (O-RANs). For example, a number of components for creating and maintaining a digital twin of a wireless network are presented. The components include a registry component configured to store services supported by digital twin processes; a three-dimensional (3D) model management component configured to provide services for selecting a 3D model; a network topology model management component configured to provide services for selecting a cellular site and associated hardware; and a UE profile model management component configured to provide services for selecting user device distribution and mobility, and traffic profiles. The components also include a radio model management component configured to provide services for selecting and generating a radio channel model; a network and UE model management component configured to provide services for network functional behavior models and UE functional behavior models; and a configuration model management component configured to provide services for selecting and creating network configurations and UE configurations for multiple protocol modules. The components further include a simulation services component configured to provide services for simulating network functional behavior and UE functional behavior; and a simulation orchestrator component configured to provide services for planning, analyzing, and optimizing network features and scenarios.

Particular aspects of the subject matter described in this disclosure can be implemented to realize one or more of the following potential advantages. In some examples, the described components, such as the radio model management component, provide improved techniques for creating and maintaining a digital twin. For example, the 3D model management component provides techniques to store and manage pre-built 3D models for use in digital twin creation. Additionally, the described components and techniques are compatible with conventional RAN architectures, allowing the components and techniques to be implemented at a lower cost than other proposed digital twin solutions that specify improved RAN architectures.

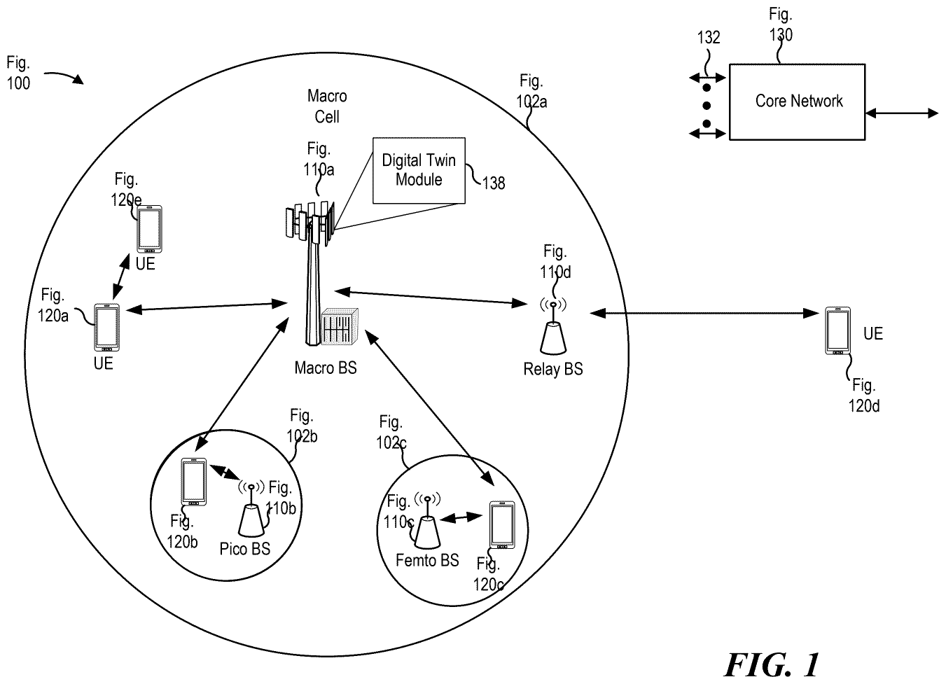

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real-time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

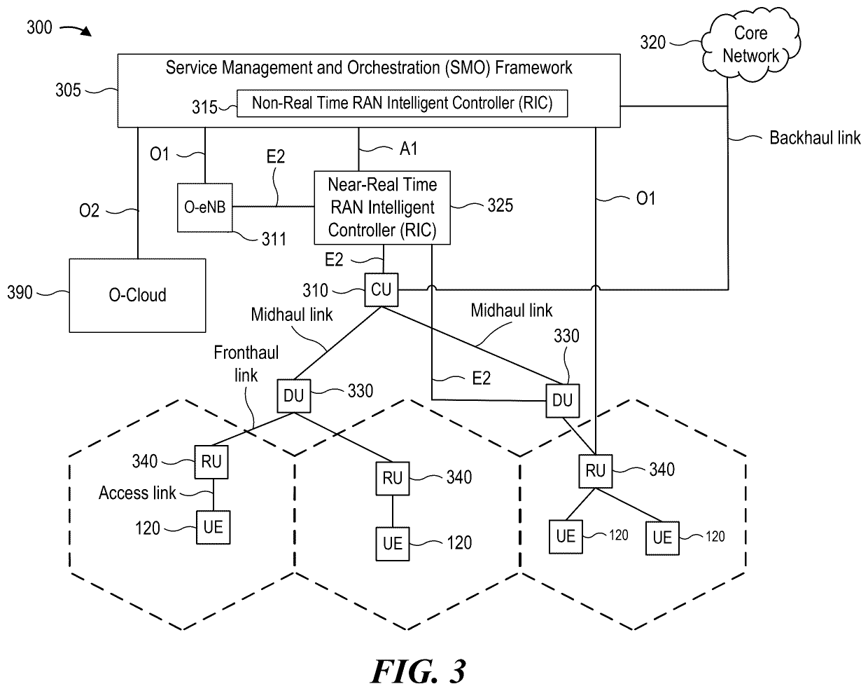

The core network 130 or the base stations 110 or any other network device (e.g., as seen in FIG. 3) may include a digital twin module 138 for storing, via a registry function, services supported by digital twin functions. The digital twin module 138 may also be used for selecting, via a 3D model management function, a 3D model. The digital twin module 138 may additionally be used for selecting, via a network topology model management function, a cellular site and associated hardware. The digital twin module 138 may also be used for selecting, via a user equipment (UE) profile model management function, user device distribution and mobility, and traffic profiles. The digital twin module 138 may further be used for selecting and generating, via a radio model management function, a radio channel model. The digital twin module 138 may also be used for providing, via a network and UE model management function, network functional behavior models and UE functional behavior models for running simulations. The digital twin module 138 may still further be used for selecting and creating, via a configuration model management function, network configurations and UE configurations for multiple protocol modules. The digital twin module 138 may also be used for simulating, via a simulation services module, network functional behavior and UE functional behavior. The digital twin module 138 may additionally be used for planning, analyzing, and optimizing, via a simulation orchestrator function, network features and scenarios.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

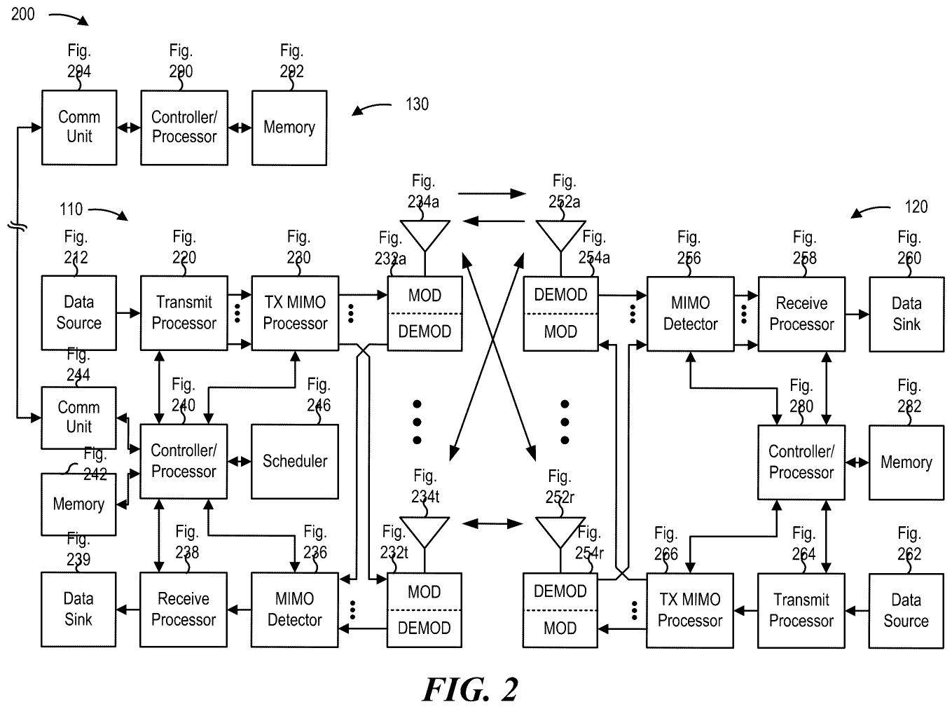

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

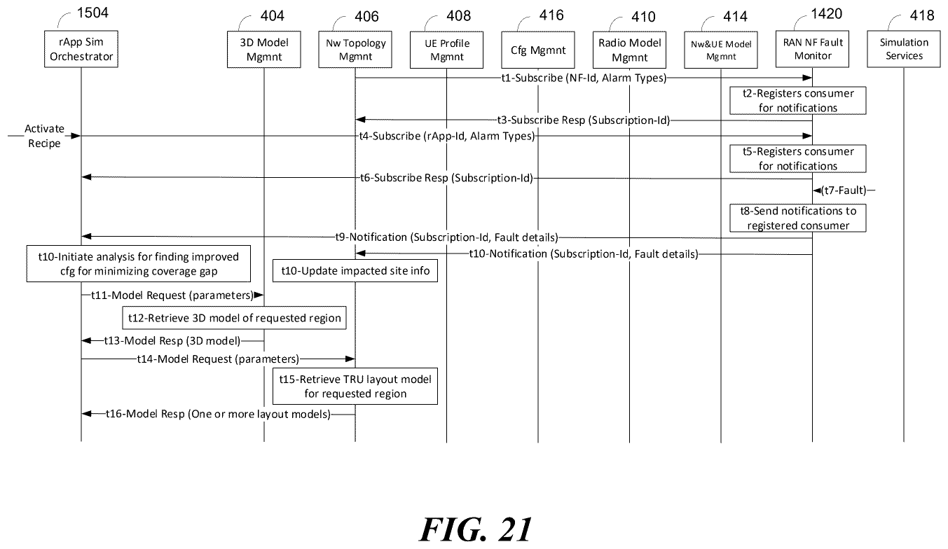

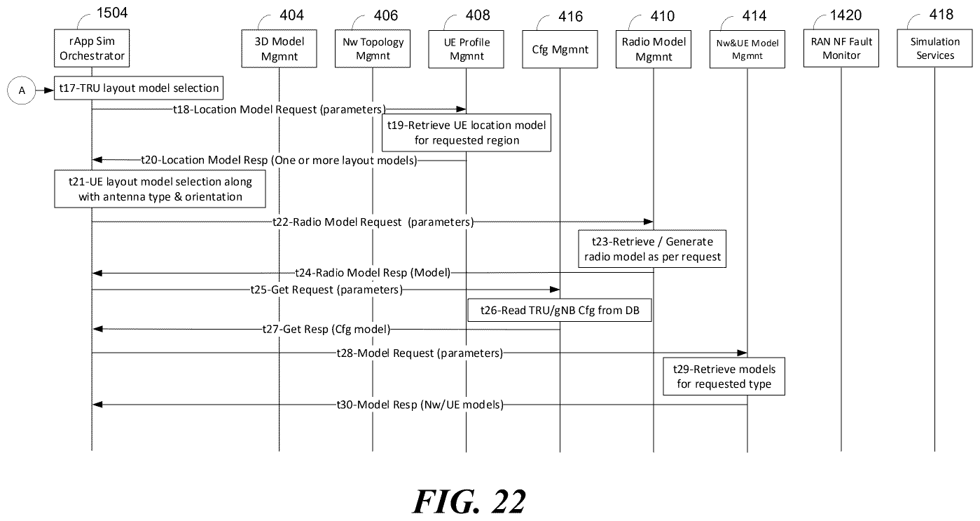

The controller/processor 240 of the base station 110, the controller/processor 280 of the UE 120, and/or any other component(s) of FIG. 2 may perform one or more techniques associated with digital twins, as described in more detail elsewhere. For example, the controller/processor 240 of the base station 110, the controller/processor 280 of the UE 120, and/or any other component(s) of FIG. 2 may perform or direct operations of, for example, the processes of FIGS. 21 and 22 and/or other processes as described. Memories 242 and 282 may store data and program codes for the base station 110 and UE 120, respectively. A scheduler 246 may schedule UEs for data transmission on the downlink and/or uplink.

In some aspects, the base station 110 may include means for storing, means for selecting, means for generating, means for providing, means for creating, means for simulating, means for planning, means for analyzing, means for optimizing, means for registering, means for transmitting, and means for inputting. For example, the means for storing, means for selecting, means for generating, means for providing, means for creating, means for simulating, means for planning, means for analyzing, means for optimizing, means for registering, means for transmitting, and means for inputting may be any of the digital twin module 238, controller/processor 240, 290, and/or the memory 242, 292. In other aspects, the aforementioned means may be any structure or any material configured to perform the functions recited by the aforementioned means.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real-time (near-RT) RAN intelligent controller (RIC) 325 via an E2 link, or a non-real-time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

As discussed, aspects of the present disclosure are directed to architecture options for enabling digital twin models in open radio access networks (O-RANs). In some implementations, a decomposed service management and orchestration (SMO) architecture is a baseline architecture for digital twin enablers.

The present disclosure presents various techniques to perform digital twin modeling. In some implementations, the digital twin is a modeling service or an intelligent service within an SMO, the service capable of being enabled on a need basis. In still other implementations, the digital twin is a co-existing parallel network to a real world network, with digital world elements interacting with real-world elements at multiple levels. Still further implementations are contemplated. Some aspects of the present disclosure are directed to architecture options. The aspects define generic architectures for digital twin enablers. The aspects also define architecture changes in a decomposed SMO for integrating digital twin enablers.

The present disclosure defines a generic architecture for building and managing a digital twin of a wireless network. The present disclosure includes foundation components for digital twin modeling, orchestrators and enablers for use-case/scenario specific analyzers and optimizers, and a framework for enabling an application ecosystem. The present disclosure also includes techniques to integrate digital twin enabler foundation components in a decomposed SMO.

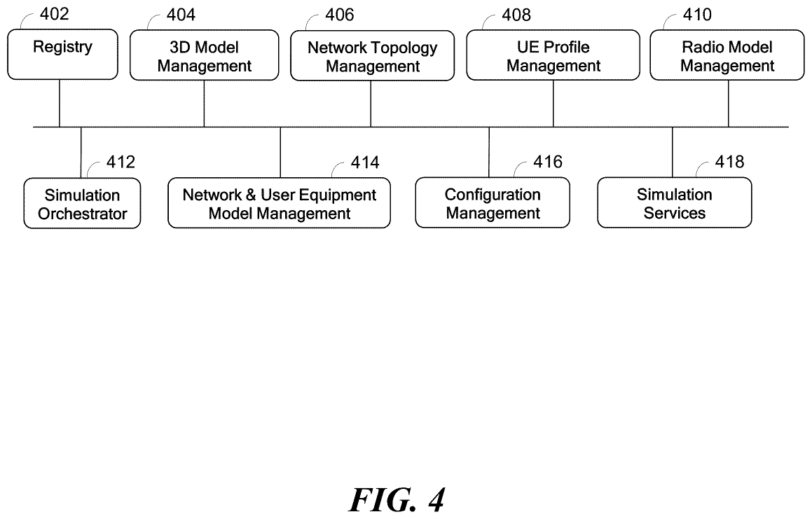

FIG. 4 illustrates an overview of digital twin as a service (DTaaS), in accordance with aspects of the present disclosure. FIG. 4 includes components for digital twin modeling. Digital twin modeling frameworks may be built with the components, allowing flexibility in hosting the components and additionally allowing the components to be hosted with operator infrastructure or remotely via infra-vendor infrastructure.

A registry component 402 includes a repository of services supported by digital twin components. The registry component 402 may also be referred to as the model repository. The registry component 402 may be configured to store models of all types that are specified for simulating end-to-end scenarios. For example, the registry component 402 may store 3D models, radio models, network models, user equipment (UE models, traffic models, RAN models, antenna models, transmit/receive unit (TRU) placement models, device placement models, mobility models, UE configuration models, network configuration models, user activity models, network usage models, device capability models, and density models. If a specified model is not locally available, the registry component 402 may implement a model import component to download the specified model from infrastructure vendor servers. Additionally, the registry component 402 may perform repository management techniques to add, modify, or delete models. The registry component 402 may also retrieve a model by receiving, as input, a type of model or a model identification (ID) and producing, as output, a model.

A three dimensional (3D) model management component 404 provides services for selecting 3D models. The 3D model management component 404 may also be referred to as the 3D model manager, and may be configured to maintain 3D models of structures such as cities, towns, and marketplaces. The 3D models maintained by the 3D model management component 404 may be physical world to digital world models including object and material tagging. The 3D model management component 404 may also extract a 3D model of a region of interest from available city or town level models. Additionally, the 3D model management component 404 may support model library management, including an add/modify/delete model application program interface (API). The 3D model management component 404 may also support techniques to retrieve a model of a requested geographical region. For example, the 3D model management component 404 may support a get model API. The get model API may receive, as an input, one or more geographic locations, radius information, and resolution. The get model API may produce, as an output, a 3D model with terrain, vegetation, and clutter.

A network topology management component 406 provides services for selecting cellular sites and hardware. The network topology management component 406 may also be referred to as the TRU location manager, network topology management function or network topology model management function. The network topology management component 406 may be configured to maintain TRU placement models of structures in cities, towns, and marketplaces, where the placement models may be based on physical world locations of base stations. Additionally, the network topology management component 406 may create a layout model of a TRU or TRUs within the geographical region of interest considered for simulation study. The TRU site locations may correspond to commissioned-active site locations, commissioned-not active site locations, or proposed site locations. The TRU site location information may include a reference to the type of radio hardware deployed at the site and the site's antenna radiation pattern and orientation configuration.

The network topology management component 406 may be configured to perform model library management techniques. For example, the network topology management component 406 may include an add/modify/delete TRU site information model API, an add/modify/delete TRU layout model API, and a register for a RAN fault manager (FM) notification API. The RAN network function (NF) FM may be configured to send a notification for any failed network element and a detailed fault report when requested for a given set of network nodes.

The network topology management component 406 may also be configured to retrieve a model for a requested geographical region. For example, the network topology management component 406 may include a get TRU layout model API. The get TRU layout model API may receive, as an input, one or more geo locations, a radius, a type of hardware, criteria for TRU placement, and explicitly disabled TRUs. The criteria for TRU placement may include a TRU density metric and a minimum inter-TRU distance. The get TRU layout model output may include a TRU location layout model including one or more base stations, or multiple layout models if more than one placement options are available.

The network topology management component 406 may also be configured to generate a model for a requested geographical region. For example, the network topology management component 406 may include a generate TRU layout model API. The generate TRU layout model API may receive, as an input, one or more geographic locations, a radius, a 3D model, criteria for TRU placement, or forbidden geographical regions. The criteria for TRU placement may include a TRU density metric and a minimum inter-TRU distance. The generate TRU layout model API may produce, as an output, a TRU location layout model, or multiple layout models if, for example, more than one placement options are available.

The UE profile model management component 408 provides services for selecting user device distribution, user device mobility, and traffic profiles. The UE profile model management component 408 may also be referred to as the UE profile management component. The UE profile model management component 408 may be configured to maintain receiver placement models of structures such as cities, towns, and marketplaces, where the placement models may be based on physical world locations of UEs. The UE profile model management component 408 may be implemented to create a layout model of one or more UEs within a geographical region of interest considered for simulation study. Receiver locations may be based on real user locations or generated locations associated with some statistical model.

The UE profile model management component 408 may also maintain mobility route plans. Information maintained for each UE may include a location, a reference to the type of services processing on the UE, a type of radio hardware, and an antenna radiation pattern and orientation configuration. The UE profile model management component 408 may also be 3D model aware and may generate UE location layouts based on indoor-outdoor spaces.

The UE profile model management component 408 may implement model library management techniques. For instance, the UE profile model management component 408 may include an add/modify/delete UE mobility information model API and an add/modify/delete UE location layout model API. The UE profile model management component 408 may also retrieve models for a requested geographical region. For example, the UE profile model management component 408 may include a get UE layout model API. The get UE layout model API may receive, as an input, one or more geographical locations, a radius, and a type of hardware. The get UE layout model API may produce, as an output, a UE location layout model including one or more UEs, or multiple layout models if more than one placement option is available. The UE profile model management component 408 may also include a get UE mobility model API. The get UE mobility model API may receive, as an input, one or more geographical locations, a radius, a type of hardware, and UE identifications. The get UE mobility model API may produce, as an output, a UE mobility model including one or more UEs. If a simulation is to be seeded with a network snapshot, then the UE profile model management component 408 may collect UE information, such as location and type of service, from a physical world network via 01-trace messages, a RAN NF PM, and/or third-party crowd sourcing platforms.

The UE profile model management component 408 may also generate a model for a requested geographical region. For example, the UE profile model management component 408 may include a generate UE layout model API. The generate UE layout model API may receive, as input, one or more geographic locations, a radius, a 3D model, a criteria for UE placement, forbidden geographical regions, and TRU locations. The criteria for UE placement may include a UE density metric, an indoor-outdoor ratio, and a type of service density. The generate UE layout model may produce, as an output, one or more UE location layout models.

A radio model management component 410 provides services for selecting and generating a radio channel model. The radio model management component 410 may also be referred to as a radio modeling component or a radio model management function. The radio model management component 410 may be configured to provide radio modeling services for generating radio models for a given scenario or 3D model. Additionally, the radio model management component 410 may perform stochastic modeling, ray-tracing based deterministic modeling, artificial intelligence (AI) and/or machine learning (ML) based modeling, or any other method of generating radio models. Once generated for a geographical region, radio models may be stored and/or maintained via a model repository service.

The radio model management component 410 may perform model generation techniques. For example, the radio model management component 410 may include a generate radio model API. The generate radio model API may receive, as an input, a 3D model, TRU and/or UE placement information, a scenario description for a stochastic model, a classification for an AI and/or ML model, an antenna model, an antenna configuration, waveform information, and channel quantities to generate. The generate radio model API may output a channel model.

A simulation orchestrator component 412 provides services for planning, analyzing, and optimizing network features and scenarios. The simulation orchestrator component 412 may also be referred to as the simulation orchestrator function. The simulation orchestrator component 412 may be configured to maintain recipes for analysis and improvement of different network features, behaviors, and performances. Additionally, the simulation orchestrator component 412 may take, as input, intent or use-case and a network or geographical region and may manage end-to-end scenario simulation and improvement. To manage end-to-end scenario simulation and improvement, the simulation orchestrator component 412 may perform model selection, data collection, simulation and/or emulation, analytics on simulation output, defining iterations specified for meeting the objective of an intent or use-case, and generating recommended configuration and placement of network elements.

The simulation orchestrator component 412 may implement recipe library management techniques. For example, the simulation orchestrator component 412 may include an add/modify/delete recipe API and a discover available recipes API. The discover available recipes API may produce, as output, a list of recipes, where the recipes may be based on a use-case such as coverage optimization, capacity estimation, energy saving, network slice feasibility evaluation, and load balancing. The simulation orchestrator component 412 may also implement techniques for activating a recipe. For example, the simulation orchestrator component 412 may include an activate recipe API. The activate recipe API may receive, as input, a recipe identification, one or more geographic locations, a radius, a resolution, and an objective. The activate recipe API may produce, as an output, a model, including TRU locations, antenna radiation pattern, antenna orientation, antenna beam configuration, network configuration, and a policy for a RAN intelligent controller.

A network and UE model management component 414 provides services for network and UE function behavior models. The network and UE model management component 414 may also be referred to as a network and UE model management function. The network and UE model management component 414 may be configured to provide network and user device behavior model services for processing simulations. The models produced or maintained by the network and UE model management component 414 may be defined in any conventional format such as any combination of emulator and/or simulator binaries, object code, and AI and/or ML models. The models produced or maintained by the network and UE model management component 414 may be generic with optional customization through configuration parameters, or the models may be specific to an infrastructure vendor or original equipment manufacturer (OEM) hardware and/or software. Input and output of the models may be standardized.

The models produced or maintained by the network and UE model management component 414 may be hosted locally within an SMO or may be implemented as a service from external platforms. For example, if an infrastructure vendor is hosting digital models corresponding to its central unit, distributed unit, or core network offering as a service, an operator may subscribe to the service and implement the models corresponding to deployed hardware and/or software for running digital twin simulations. The service may be invoked by the simulation orchestrator component 412 for specific network elements or UE hardware or software configurations.

The network and UE model management component 414 may be configured to perform simulation management. For example, the network and UE model management component 414 may include a get network model API, a get UE model API, and a discover API. The get network model API may receive, as an input, network element details, including a vendor, node type, and version. The get network model API may produce, as an output, a model, including binaries, AI and/or ML information, and an object library. The get UE model API may receive, as an input, user device details, including an original equipment manufacturer, a device type, and a version. The get UE model API may produce, as an output, a model, including binaries, AI and/or ML information, and an object library. The discover API may receive, as an input, a type of element and/or device, vendor information, original equipment manufacturer information, and technology. The discover API may produce, as an output, details of available models of a requested type.

A configuration management component 416 provides services for selecting and creating network and UE configurations for various protocol modules. The configuration management component 416 may also be referred to as the network configuration manager, the configuration model management function, or the configuration model management component. The configuration management component 416 may be configured to maintain network and UE configuration models corresponding to either existing configurations of a physical world RAN or proposed configurations for new features and/or services that are simulated via the digital twin.

The UE configuration models may have different protocol layer parameter configurations. The configuration management component 416 may also maintain a mapping between identifications such as TRU identifications and base station (e.g., gNB) identifications. Additionally, the configuration management component 416 may also register for notification any configuration changes applied by a RAN network function (NF) configuration monitor (CM) component in a physical world RAN. The configuration management component 416 may also pull configuration details from the RAN NF CM when specified to create a seed configuration for a what-if analysis.

The configuration management component 416 may implement model library management techniques. For example, the configuration management component 416 may include an add/modify/delete RAN configuration model API, an add/modify/delete UE configuration model API, and a register for RAN CM configuration changes API. For the register for RAN CM configuration changes API, the RAN NF CM may send notifications of any configuration change, as well as a detailed configuration, when requested for a given set of network nodes.

The configuration management component 416 may also implement techniques to retrieve configuration models for network elements in a requested geographical region. For example, the configuration management component 416 may include a get active RAN configuration model API for providing a snapshot of active configurations on different RAN nodes. The get active RAN configuration model API may receive, as input, identifications such as a list of unique TRU identifications and a list of unique base station identifications. The get active RAN configuration model API may produce, as an output, configuration models corresponding to input TRU identifications and base station identifications.

The configuration management component 416 may also implement a get RAN configuration model API for getting models from a stored model library. The get RAN configuration model API may receive, as input, identifications such as a list of unique TRU identifications and a list of unique base station identifications. The get RAN configuration model API may produce, as an output, configuration models corresponding to input TRU identifications and base station identifications. The configuration management component 416 may also implement a get UE configuration model API for getting a model from a stored model library. The get UE configuration model API may receive, as an input, a UE type and capability. The get UE configuration model API may produce, as an output, configuration models based on an input UE type.

A simulation services component 418 provides services for simulating network and UE functional behavior. The simulation services component 418 may be configured to provide simulation services for performing end-to-end simulations, receiving input such as radio, network, UE, or traffic models and scenario configurations. The simulation services component 418 may be implemented by the simulation orchestrator component 412 for specified scenarios and configurations. Additionally, the simulation services component 418 may support simulation management techniques. For example, the simulation services component 418 may include a simulation request API. The simulation request API may receive, as an input, a radio model, a network model, a UE model, a traffic model, a network and UE configuration, designated information to monitor, and a simulation termination condition. The designated information to monitor may include performance managers, counters, states, and events. The simulation termination condition may be based on a duration and/or event. The simulation request API may produce, as an output, monitored counters, indicators, events, and logs.

The digital twin foundation services may not make a specific choice on realization but may focus on functional specifications performed by the components. The components may either be part of the platform as foundational services in the SMO, or may be non-real-time radio access network intelligent controller applications (rApps), or any combination of both. The components may include an independently managed data and model repository, where the repository may have models available within the operator domain, or externally hosted on infrastructure-vendor or third-party domains. The components may be standardized to a stage-1, stage-2, or stage-3 level, but for some components, stage-standardization is likely sufficient.

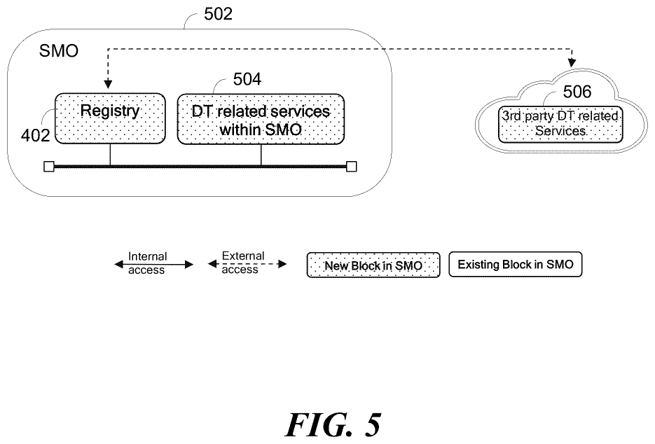

FIG. 5 illustrates a DTaaS registry component, in accordance with aspects of the present disclosure. A registry component 402 and digital twin (DT) related services within an SMO 504 are both integrated with an SMO 502. The registry component 402 shares internal SMO access with the digital twin related services within the SMO 504. The registry component 402 shares external access with third-party digital twin related services 506.

The registry component 402 manages registration of services offered by other digital twin functions. If foundation services are offered by external or third-party platforms, the registry component 402 may also provide exposure functions. In some implementations, the registry component 402 provides discovery functions for available digital twin related services, such as the digital twin related services within the SMO 504 or the third-party digital twin related services 506. The registry component 402 may support application programming interfaces (APIs), such as an API for registering, modifying, and de-registering services. The registry component 402 may also support a discover API.

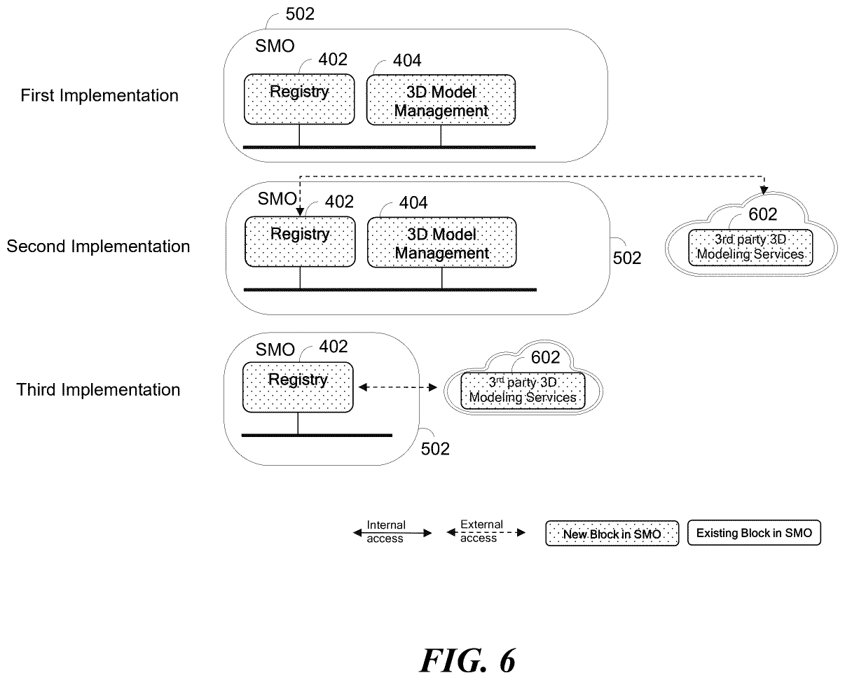

FIG. 6 illustrates a DTaaS three-dimensional (3D) model management component, in accordance with aspects of the present disclosure. In a first implementation, the SMO 502 includes the registry component 402 in internal communication with the 3D model management component 404. The registry component 402 may include 3D model management services, and all 3D models and management components may be hosted within the SMO 502. In a second implementation, the SMO 502 includes the registry component 402 in internal communication with a 3D model management component 404. The registry component 402 may also be in external communication with third-party 3D modeling services 602. In the second implementation, the registry component 402 may include third-party offered services and 3D model management services. A 3D map or model service may be provided by a third-party and some management functions may be hosted within the SMO 502. In a third implementation, an SMO 502 includes a registry component 402 in external communication with third-party 3D modeling services 602. The registry component 402 may include 3D model management services. In the third implementation, all 3D models and management functions may be hosted by a third-party.

The 3D model management component 404 may store and manage pre-built 3D models of structures such as cities, towns, marketplaces, and buildings. The 3D models may be digital models of the physical world, with object and material tagging. The 3D model management component 404 may also create and extract a 3D model of a region of interest from available city or town level models for requested resolution and details. Further, the 3D model management component 404 may act as an intermediary in implementations where the 3D model management services are hosted by external or third-party platforms that may offer paid or open map services. For example, the 3D model management component 404 may act as an intermediary between the external 3D model management services and components integrated with the SMO 502. For APIs, the 3D model management component 404 may include an add/modify/delete API as well as an API to get a 3D model.

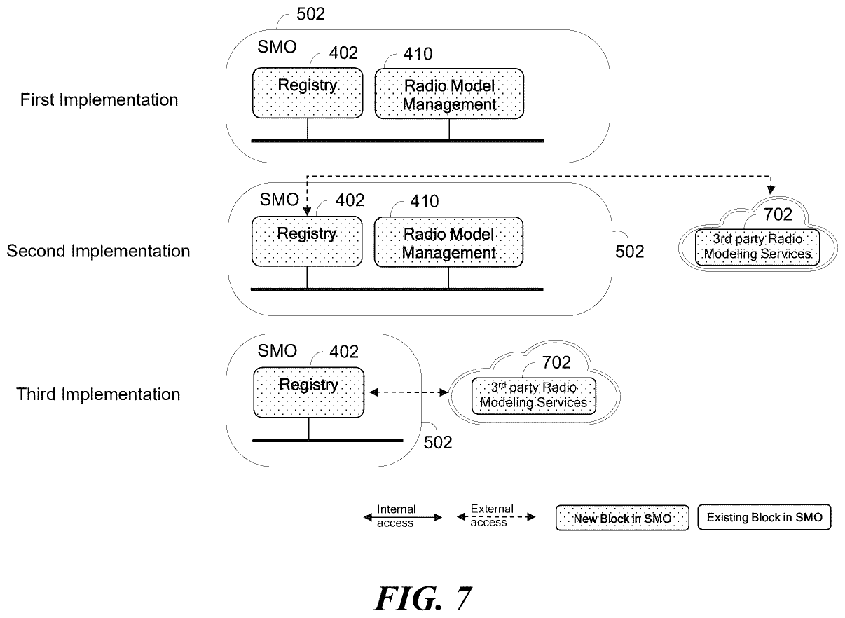

FIG. 7 illustrates a DTaaS radio model management component, in accordance with aspects of the present disclosure. In a first implementation, the registry component 402 is in internal communication with the radio model management component 410. In the first implementation, all radio modeling and management functions may be hosted within the SMO 502. In a second implementation, the registry component 402 is in internal communication with the radio model management component 410. The registry component 402 is also in external communication with third-party radio modeling services 702. In the second implementation, some radio models and modeling services may be provided by a third-party, and some management and hybrid modeling functions may be hosted within the SMO 502. In a third implementation, the registry component 402 is in external communication with third-party radio modeling services 702. In the third implementation, all radio models and modeling management functions may be hosted by a third-party.

The radio model management component 410 may provide radio modeling services for generating radio models for a given scenario or 3D model. The services may perform techniques such as stochastic modeling, ray-tracing based deterministic modeling, artificial intelligence (AI) and machine learning (ML) based modeling, or any other hybrid technique of generating radio models. Once generated for a geographical region, radio models may be stored via a model repository. The radio model management component 410 may also act as an intermediary in implementations where radio modeling services are hosted by external or third-party platforms that may offer paid or open map services. For example, the radio model management component 410 may act as an intermediary between the radio modeling services and components integrated with the SMO 502. The radio model management component 410 may include a generate radio model API, an add/modify/delete radio model API, and a discover API.

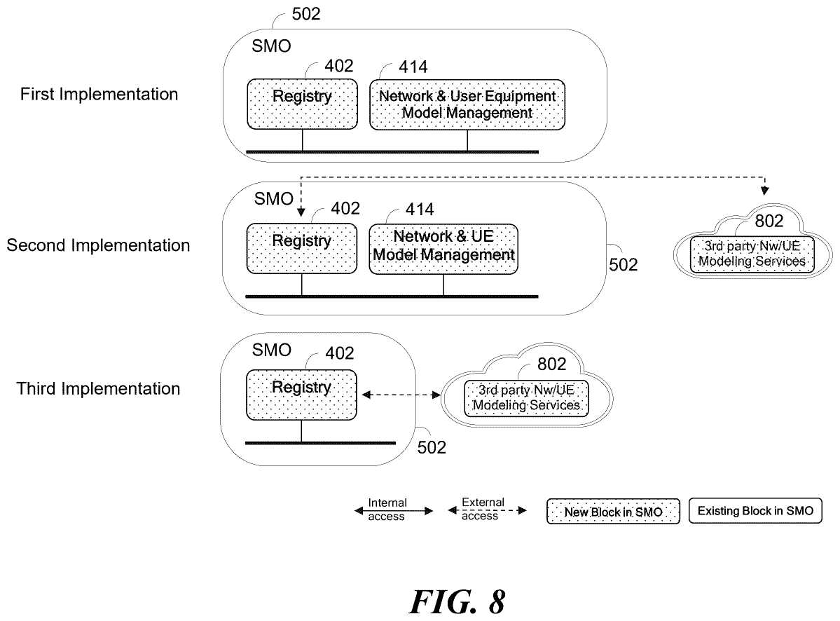

FIG. 8 illustrates a DTaaS network and UE model management component, in accordance with aspects of the present disclosure. In a first implementation, the SMO 502 includes the registry component 402 in internal communication with the network and the UE model management component 414. In the first implementation, all network and UE modeling management functions may be hosted within the SMO 502. In a second implementation, the SMO 502 includes the registry component 402 in internal communication with the network and the UE model management component 414. The registry component 402 is also in external communication with third-party network and UE modeling services 802. In the second implementation, some models may be provided by third-party services, and some models may be hosted within the SMO 502. In a third implementation, the SMO 502 includes the registry component 402 in external communication with third-party network and UE modeling services 802. In the third implementation, all models and management functions may be hosted by the third-party.

The network and UE model management component 414 may store and manage pre-defined radio access network (RAN), core network and UE behavior models. Models may be represented as any combination of simulator/emulator binaries, AI/ML models, or other standard format of model definition. Additionally, models may be generic or specific to a vendor or original equipment manufacturer (OEM). The network and UE model management component 414 may also act as an intermediary in implementations where network or UE model functions are hosted by external or third-party platforms, such as an infrastructure vendor platform or a platform provided by an OEM. For example, the network and UE model management component 414 may act as an intermediary between the network and user equipment modeling services and components integrated with the SMO 502. The network and UE model management component 414 may include a get network model API, a get UE model API, a discover API, and a add/modify/delete model API.

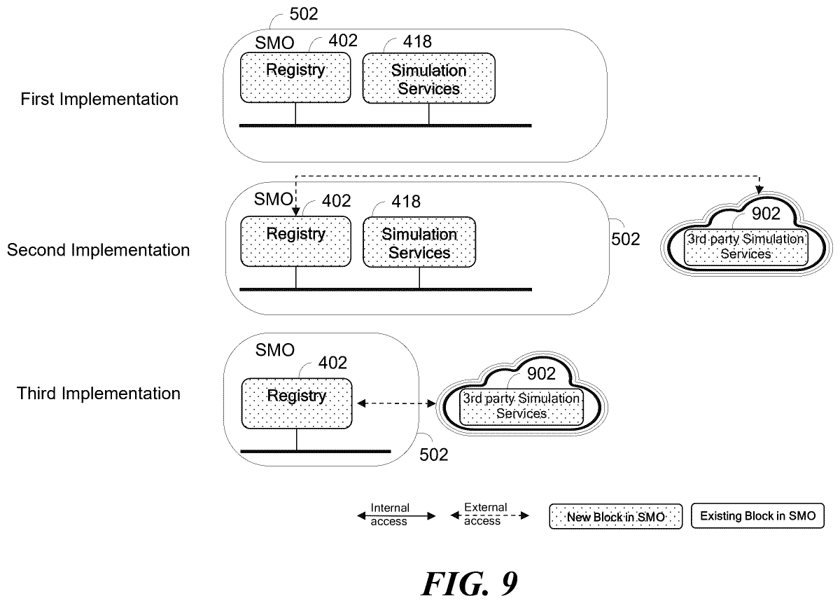

FIG. 9 illustrates DTaaS simulation services (SS) component, in accordance with aspects of the present disclosure. In a first implementation, the SMO 502 includes the registry component 402 in internal communication with the simulation services component 418. In the first implementation, all simulation services may be hosted within the SMO 502. In a second implementation, the SMO 502 includes the registry component 402 in internal communication with the simulation services component 418. The registry component 402 is also in external communication with third-party simulation services 902. In the second implementation, some simulation options may be provided by third-party services, and some simulation options may be hosted within the SMO 502. In a third implementation, the SMO 502 includes the registry component 402 in external communication with third-party simulation services 902. In the third implementation, all service options may be hosted by the third-party.

The simulation services component 418 provides services for simulating network and UE functional behavior. For example, the simulation services component 418 may receive radio, network, UE, and traffic models or scenario configurations as input. The simulation services component may then provide services for performing end-to-end simulations. The simulation services component 418 may also generate simulation output, logs, and reports in defined formats. Additionally, the simulation services component 418 may act as an intermediary in implementations where simulation services are hosted by external or third-party platforms, such as an infrastructure vendor platform. For example, the simulation services component 418 may act as an intermediary between the third-party simulation services and components integrated with the SMO 502. The simulation services component 418 may additionally support a simulation request API.

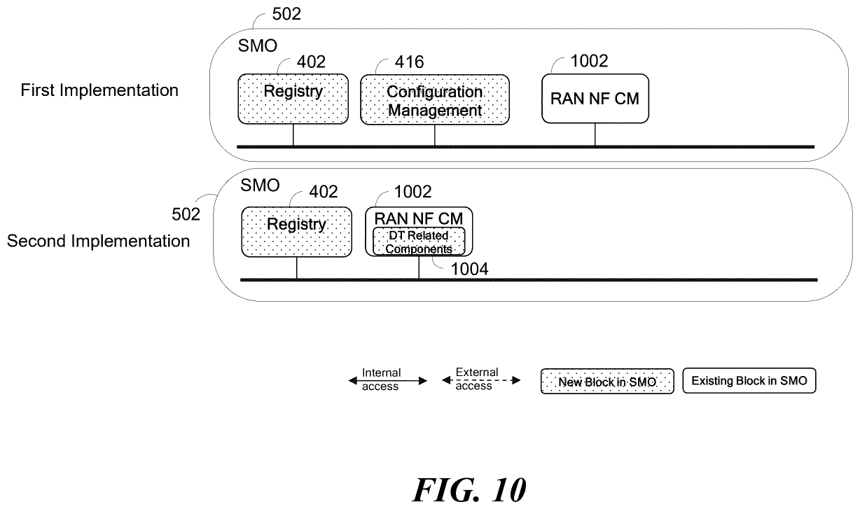

FIG. 10 illustrates a DTaaS configuration model management component, in accordance with aspects of the present disclosure. In a first implementation, the SMO 502 includes the registry component 402 in internal communication with the configuration management component 416 and a RAN network function (NF) configuration monitor (CM) 1002. The RAN NF CM component 1002 may generate network configurations for a digital twin from a group of stored configurations. In the first configuration, all configuration storage and management components may be hosted in the configuration management component 416. The configuration management component 416 may internally implement RAN NF CM APIs for receiving a snapshot of an applied configuration. In a second configuration, the SMO 502 includes the registry component 402 in internal communication with the RAN NF CM component 1002. The RAN NF CM component 1002 includes digital twin (DT) related components 1004. For example, the digital twin related components 1004 may include components related to pre-defined configuration, storage, and management functions for a digital twin.

The configuration management component 416 stores and manages configuration sets for RAN, core network, and UE models. The configuration management component 416 may also create new configuration sets on-demand based on an active RAN, core network, and/or UE configuration. Additionally, the configuration management component 416 may acquire active configuration sets from RAN or core network elements. The configuration management component 416 may include an add/modify/delete RAN configuration model API, an add/modify/delete UE configuration model API, a get active RAN configuration model API, a get RAN configuration model API, and a get UE configuration model API. The configuration management component 416 may implement a get active configuration model API from the RAN NF CM component 1002.

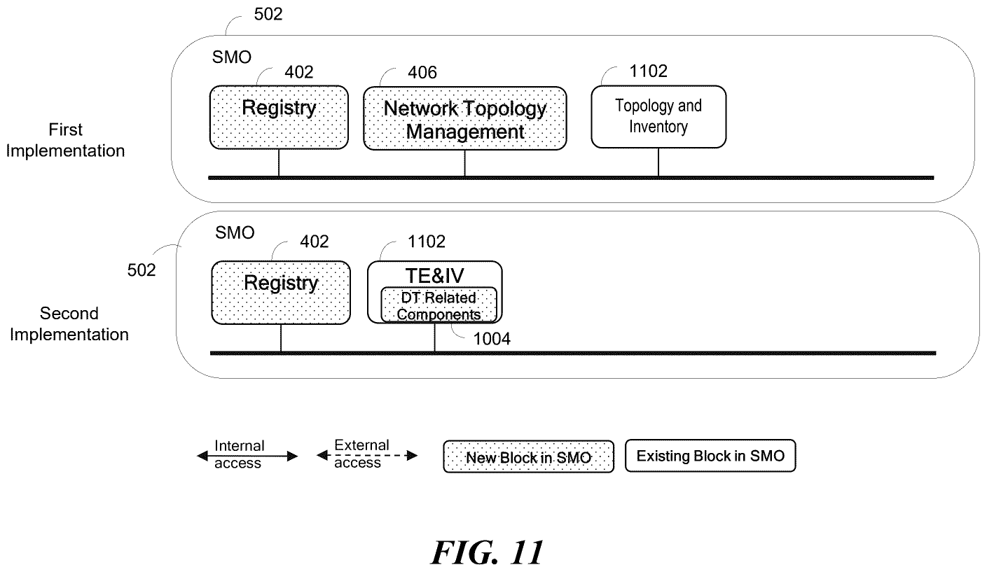

FIG. 11 illustrates a DTaaS network topology management component, in accordance with aspects of the present disclosure. In a first implementation, the SMO 502 includes the registry component 402 in internal communication with the network topology management component 406 and a topology exposure (TE) and inventory management (IV) component 1102. In the first implementation, all network site information storage and layout management components may be hosted in the network topology management component 406. The network topology management component 406 may implement TE and IV APIs for receiving installed site and hardware information. In a second implementation, the SMO 502 includes the registry component 402 in internal communication with the topology exposure and inventory management component 1102. The topology exposure and inventory management component 1102 may include digital twin related components 1004. For example, the digital twin related components 1004 may include components for green field layout planning and management functions for a digital twin.

The network topology management component 406 may store and manage the TRU site locations corresponding to physical world locations of base stations. The status of the TRUs may be, for example, commissioned-active, commissioned-not active, or a proposed site location. The information of each TRU site location may contain a geographic location, a reference to the type of radio hardware deployed at the site, and the radio hardware's antenna radiation pattern and orientation configuration. The network topology management component 406 may also create a layout model of TRU placement based on received criteria, such as geographical region, type of hardware, access technology, and TRUs to be removed or disabled. Therefore, the network topology management component 406 is useful for creating layouts without removed, disabled, faulty, and/or energy-saving candidates.

The network topology management component 406 may also create a layout model of new or non-existing TRU placement layout sets based on a received criteria for purposes such as green field planning. The network topology management component 406 may include an add/modify/delete TRU site information model API, an add/modify/delete TRU layout model API, a get TRU layout model API, and a generate TRU layout model API. The network topology management component 406 may implement a notification of site information model update API from, for example, a RAN NF fault manager (FM), RAN NF CM, or RAN NF operator.

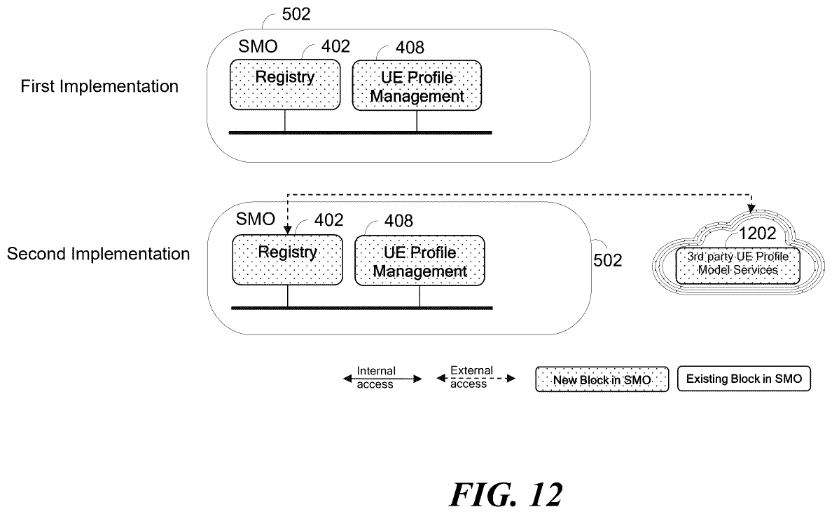

FIG. 12 illustrates a DTaaS UE profile management component, in accordance with aspects of the present disclosure. In a first implementation, the SMO 502 includes the registry component 402 in internal communication with the UE profile model management component 408. In the first implementation, all subscriber layout, mobility models, and management components may be hosted in the UE profile model management component 408. In a second implementation, the SMO 502 includes the registry component 402 in internal communication with the UE profile model management component 408. The registry component 402 is also in external communication with third-party UE profile model services 1202. In the second implementation, some or all models may be provided by third-party services, and components for generating layouts from active physical world UE locations may be hosted in the SMO 502.

The UE profile model management component 408 stores and manages user device placement models corresponding to physical world locations of UEs. Subscriber placement layouts may be either pre-defined or generated based on some statistical distribution model, where the type of distribution model may be based on a use-case. In some examples, subscriber placement layouts may be generated based on active user locations in a physical world network. The generation of active user locations in a physical world network may specify user location information from network traces. In mobility use-cases, subscriber mobility routes may be either pre-defined or generated based on an active user mobility trace from the physical world network.

The UE profile model management component 408 may create a layout model of subscribers within the geographical region of interest considered for simulation study. Information of each subscriber may include information such as geographical location, a reference to the type of services running on a UE, a type of radio hardware, and antenna radiation pattern and orientation configuration. The UE profile model management component 408 may also be 3D model aware, including awareness of terrain, vegetation, and clutter, and may generate UE location layouts based on information such as indoor-outdoor spaces and forbidden zones. The UE profile model management component 408 may also act as an intermediary in implementations where the user device placement models are hosted by external or third-party platforms. For instance, models may be built on crowd sourced data such as device density, device location, type of devices/technology, type and usage pattern of services, and quality of service (QOS) and quality of experience (QoE) patterns. The UE profile model management component 408 may provide an add/modify/delete UE mobility information model API, an add/modify/delete UE location layout model API, a get UE layout model API, a get UE mobility model API, and a generate UE layout model API. The UE profile model management component 408 may implement a notifications of trace data availability API from a RAN NF performance manager (PM) component.

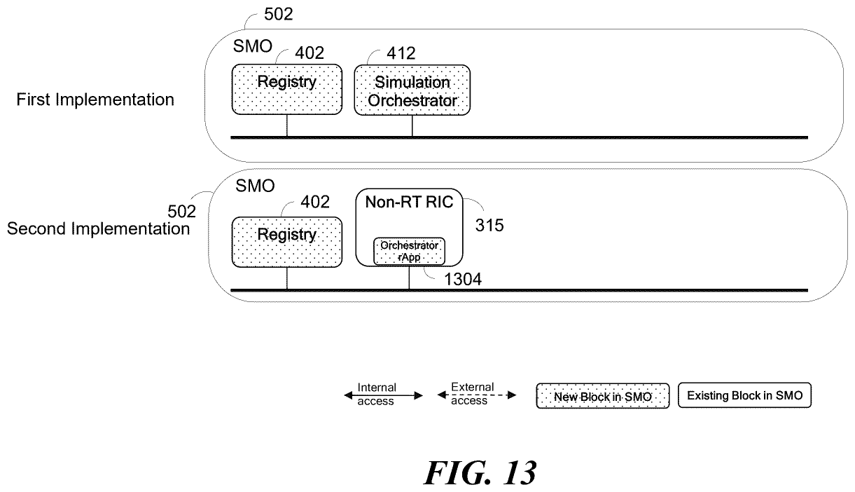

FIG. 13 illustrates a DTaaS simulation orchestrator component, in accordance with aspects of the present disclosure. In a first implementation, the SMO 502 includes the registry component 402 in internal communication with the simulation orchestrator component 412. In the first implementation, recipes may be stored or executed by the simulation orchestrator component 412 based on a trigger from an operator. Internally, the SMO 502 may implement APIs for digital twin components as well as legacy SMO components. In a second implementation, the SMO 502 includes the registry component 402 in internal communication with a non-real-time RAN intelligent controller (non-RT RIC) component 315. The non-RT RIC component 315 stores an orchestrator rAPP 1304. The orchestrator rAPP 1304 stores and executes complete recipes based on a monitor trigger or operator actions. The recipes implement APIs for digital twin and legacy SMO components.

The simulation orchestrator component 412 may store and manage recipes for analyzing and improving network features, behavior, and performance. The simulation orchestrator component 412 may receive an intent, use-case, network, and/or geographical region as input and perform end-to-end scenario simulation and improvement. As part of orchestration, the simulation orchestrator component 412 performs model selection, data collection, simulation/emulation, analytics on simulation output, defining iterations specified for meeting an objective of the intent/use-case, and generating recommended configuration and placement of network elements. The recipes may include a combination of conventional AI and ML techniques. The simulation orchestrator component 412 may provide an add/modify/delete recipes API, a discover available recipes API, and an activate recipe API. The simulation orchestrator component 412 may implement a notifications from RAN NF FM/CM/PM/operator API, a get 3D model from 3D model management component API, a get/generate TRU layout model from network topology management component API, a generate radio model from radio model management component API, a get RAN/UE configuration model from configuration model management component API, and a simulation request from network and UE model management component API.

FIGS. 5, 6, 7, 8, 9, 10, 11, 12, and 13 illustrate various components via various implementations. The implementations are provided for explanatory purposes, and are non-limiting and non-exclusive. Additionally, the illustrated implementations do not limit other implementations. For example, the second implementation illustrated and described with respect to FIG. 13 does not limit the second implementation illustrated and described with respect to FIG. 12.

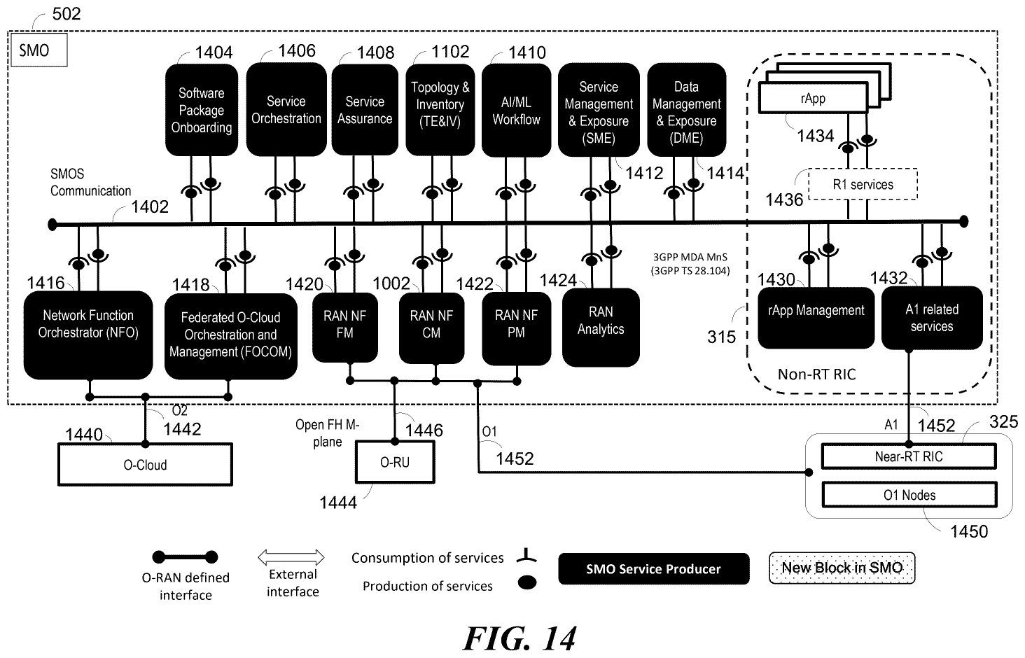

FIG. 14 illustrates a baseline O-RAN SMO architecture, in accordance with aspects of the present disclosure. As shown in FIG. 14, the SMO 502 includes a SMO system (SMOS) communication interface 1402. Some components are coupled to the SMOS communication interface 1402, including a software package onboarding component 1404, a service orchestration component 1406, a service assurance component 1408, a topology exposure and inventory management component 1102, an AI/ML workflow component 1410, a service management and exposure component (SME) 1412, a data management and exposure (DME) component 1414, a network function orchestrator (NFO) component 1416, a federated open cloud (O-cloud) orchestration and management (FOCOM) component 1418, a RAN NF FM component 1420, a RAN NF CM component 1002, a RAN NF performance manager (PM) component 1422, and a RAN analytics component 1424.

The SMO 502 also includes a non-RT RIC component 315. The non-RT RIC component 315 includes an rApp management component 1430, A1 related services 1432, and rAPP 1434 coupled to the SMOS communication interface 1402. The rAPP 1434 implements R1 services 1436. External to the SMO 502, an O-cloud component 1440 communicates with the network function orchestrator component 1416 and federated O-cloud orchestration and management component 1418 via an O2 interface 1442. An O-RAN radio unit (O-RU) component 1444 implements an open fronthaul (FH) management plane (M-plane) interface 1446 to communicate with the RAN NF FM component 1420, RAN NF CM component 1002, and RAN NF PM component 1422. A near-RT RIC component 325 and O1 nodes 1450 communicate with the RAN NF FM component 1420, RAN NF CM component 1002, and RAN NF PM component 1422 via an O1 interface 1452. The near-RT RIC component 325 communicates with the A1 related services 1432 via an A1 interface 1452.

The SMOS communication interface 1402 facilitates communication between SMOS system components and RAN elements, enabling orchestration and management of RAN services and resources. The software package onboarding component 1404 provides compatibility and functionality by managing the onboarding process of software packages onto RAN infrastructure. The service orchestration component 1406 coordinates the deployment and management of services across the RAN and improves resource utilization and performance. The service assurance component 1408 monitors the quality and reliability of services delivered by the RAN. The topology exposure and inventory management component 1102 performs testing, evaluation, and integration verification of RAN components. The AI/ML workflow component 1410 implements artificial intelligence and machine learning techniques to analyze RAN data and optimize network performance and efficiency.

The service management and exposure component 1412 provides service and management and exposure for configuring RAN elements and services and may register discoverable services of a digital twin. The data management and exposure component 1414 performs storage, retrieval, and exposure of RAN data. The network function orchestrator component 1416 manages network functions orchestration within the RAN. The federated O-cloud orchestration and management component 1418 oversees the configuration and management of the RAN's fault detection and correction mechanisms, enhancing network reliability and availability. The RAN NF FM component 1420 performs fault management within the RAN network functions, detecting, isolating, and resolving issues to maintain service continuity. The RAN NF CM component 1002 manages the configuration of RAN network components and monitors whether the RAN network components operate according to specified parameters and specifications. The RAN NF PM component 1422 monitors and configures RAN component settings. The RAN analytics component 1424 analyzes data from the RAN to provide insights into network performance, user behavior, and optimization opportunities.

The non-RT RIC component 315 performs non-real-time RAN intelligent controller techniques to provide intelligence and decision-making capabilities for improving RAN resources and services. The rApp management component 1430 oversees the management and deployment of radio applications within the RAN. A1 related services 1432 encompass various services and functionalities provided through the A1 interface for automated management and improvement of RAN resources. The rAPP 1434 represents one or more software applications designed to process on or interact with elements within the RAN. R1 services 1436 encompass functionalities and services provided by the RAN at an R1 interface. The O-cloud component 1440 is cloud infrastructure supporting Open RAN deployments, providing scalability, flexibility, and resource pooling for RAN processes and services. The O2 interface 1442 facilitates communication between the O-RAN radio unit component 1444 and components integrated with the SMO 502, such as the RAN NF FM component 1420.

The O-RAN radio unit component 1444 is a radio unit configured for transmitting and receiving radio signals in a wireless communication system, such as discussed with respect to FIG. 3. The O-RAN radio unit component 1444 may interface with baseband units and user equipment. The open front haul management plane interface 1446 enables communication within the fronthaul management plane of the RAN in an open and standardized manner. The near-RT RIC component 325 performs near-real-time RAN intelligent controller techniques and provides decision-making capabilities for optimizing RAN resources and services. O1 nodes 1450 are nodes within the O1 interface responsible for management and control techniques within the O-RAN architecture. The O1 interface 1452 is a management interface in the Open RAN framework that enables communication between a O-RAN central unit and other components for management and control techniques, such as discussed with respect to FIG. 3. The A1 interface 1442 facilitates communication between a network management system and RAN components for automated management and optimization of network resources.

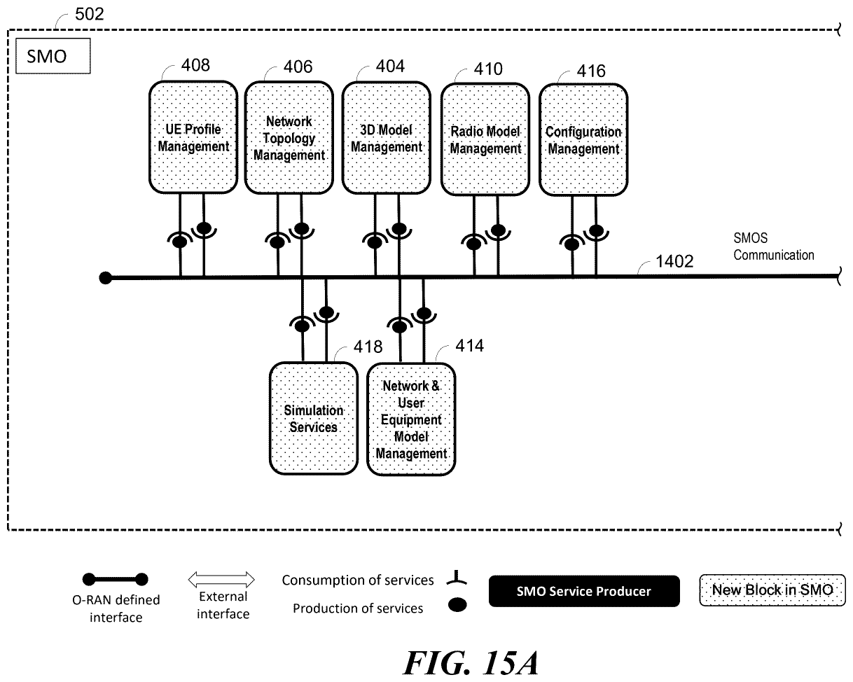

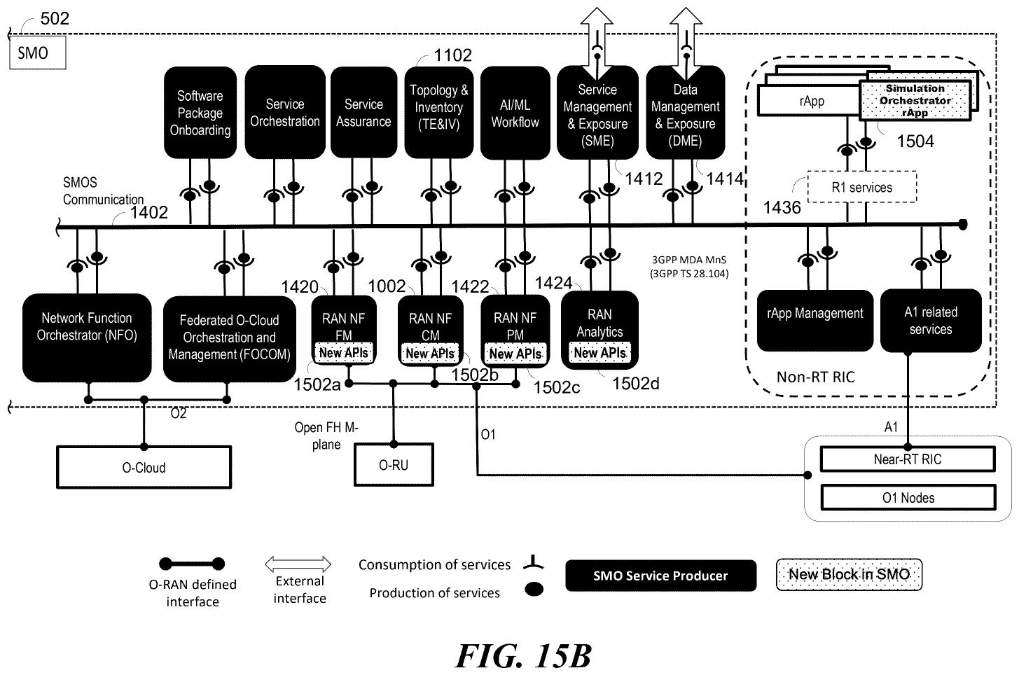

As discussed and illustrated with respect to the following FIGS. 15A-B, 16A-B, 17A-B, 18A-B, 19A-B, and 20, multiple architecture implementations integrate digital twin into the O-RAN architecture. In some implementations, only foundation components are supported as a part of SMO components. In still other implementations, foundation components and a function orchestrator are supported as a part of SMO components. In further implementations, all digital twin related services are supported as rApps.

FIGS. 15A and 15B illustrate a DTaaS foundation architecture implementation, in accordance with aspects of the present disclosure. For ease of viewing, the DTaaS foundation architecture implementation is divided into two separate figures, FIGS. 15A and 15B. As shown in FIGS. 15A and 15B, the SMO 502 includes the UE profile model management component 408, network topology management component 406, 3D model management component 404, radio model management component 410, configuration management component 416, simulation services component 418, and network and UE model management component 414. Each component communicates with other components in the SMO 502 via the SMOS communication interface 1402. Additionally, the RAN NF FM component 1420 includes new APIs 1502a, the RAN NF CM component 1002 includes new APIs 1502b, the RAN NF PM component 1422 includes new APIs 1502c, and the RAN analytics component includes new APIs 1502d. A simulation orchestrator rAPP 1504 is also in communication with the SMOS communication interface 1402.

The network topology management component 406 may internally implement topology exposure and inventory management services to process actual site locations and hardware information. Similarly, the configuration management component 416 may internally implement RAN NF CM services to process actual configuration information. Digital twin related services may be registered at the service management and exposure component 1412 and/or the data management and exposure component 1414. Each of the new APIs 1502a, 1502b, 1502c, and 1502d may be implemented for notifying performance reports, providing trace logs, notifying configuration changes, and/or providing fault reports.

In the implementation illustrated with respect to FIGS. 15A and 15B, use-case specific improvement and analysis techniques may be performed by rApps. For example, an rApp may be configured to monitor RAN NF PM, FM, and CM data and configurations to trigger digital twin-based modeling of a configuration. Digital twin related rApps may have access to all components, techniques, and data supported by the SMO 502. The SMO 502 also implements the simulation orchestrator rAPP 1504 based on a use-case, such as coverage optimization, capacity estimation, energy saving, network slice feasibility evaluation, and load balancing.

The implementation illustrated with respect to FIGS. 15A and 15B affects baseline SMO components. For example, the service management and exposure component 1412 may perform techniques based on indications from a registry component. Digital twin related services, both internal and external, may be registered with the service management and exposure component 1412. The RAN NF CM component 1002 supports additional APIs for providing a snapshot of active RAN configuration on a request-basis. Additionally, the RAN NF CM component 1002 supports additional functionality for providing notifications to a registered subscriber when a RAN configuration change occurs. The RAN NF FM component 1420 supports additional functionality for notifying a registered subscriber based on receiving a fault indication or monitored alarm indication. The RAN NF PM component 1422 supports additional functionality for providing performance reports, trace logs, and subscriber device location information. The topology exposure and inventory management component 1102 provides cellular site location layout information based on geographical region input or a generating placement hypothesis for non-existent cellular site locations.

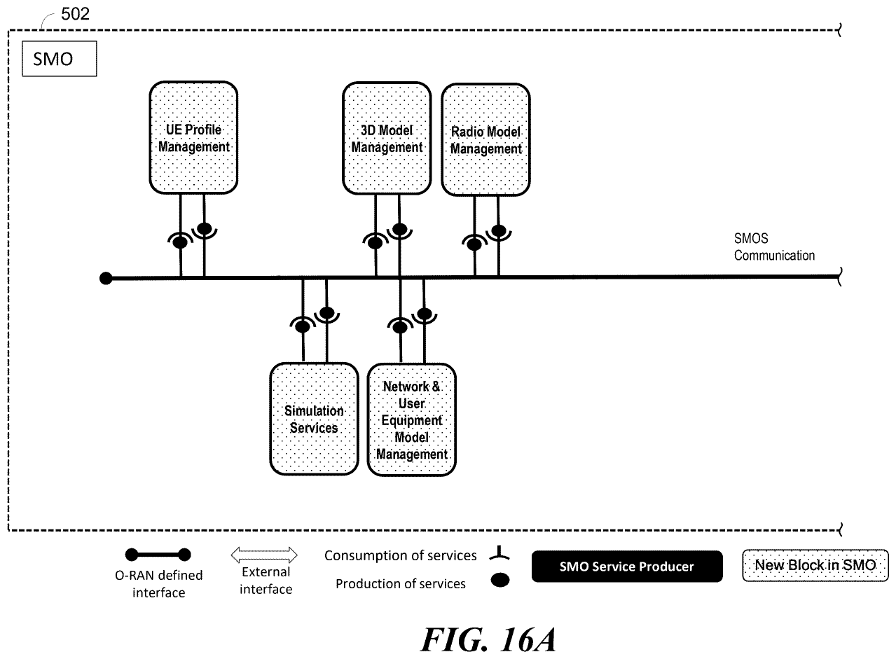

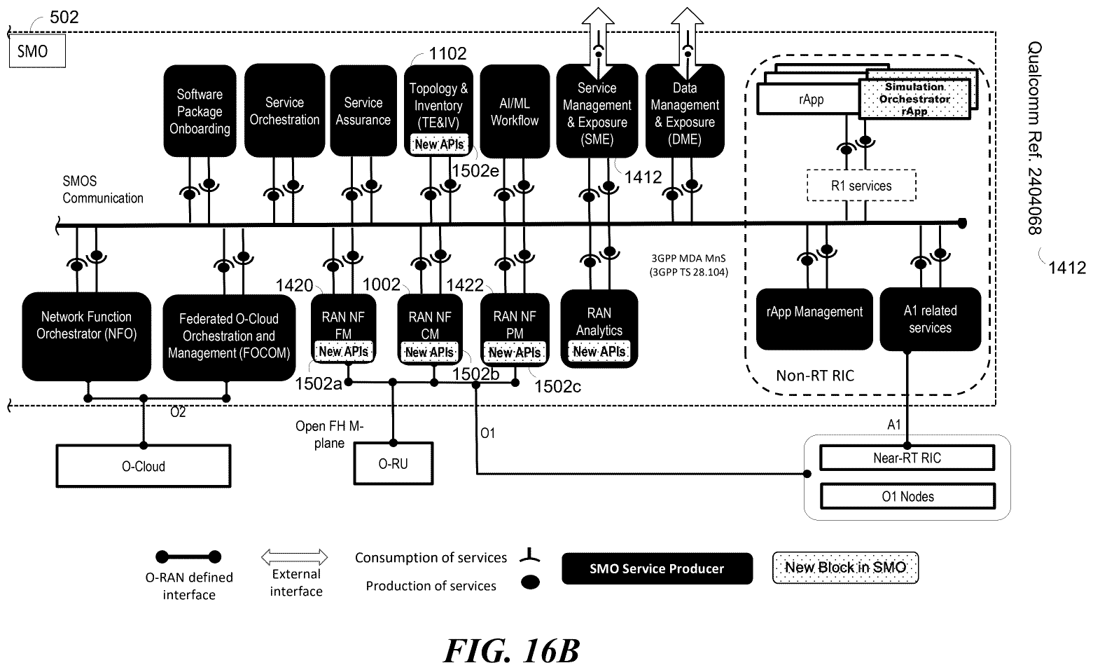

FIGS. 16A and 16B illustrate a DTaaS foundation architecture implementation, in accordance with aspects of the present disclosure. For ease of viewing, the DTaaS foundation architecture implementation is divided into two separate figures, FIGS. 16A and 16B. As shown in FIGS. 16A and 16B, various components may include new APIs for performing additional techniques. The RAN NF FM component 1420 may include new APIs 1502a for indicating fault reports. The RAN NF CM component 1002 may include new APIs 1502b for indicating configuration change reports and providing additional functionality for configuration generation. The RAN NF PM component 1422 may include new APIs 1502c for indicating performance reports and trace logs. Additionally, the topology exposure and inventory management component 1102 may include new APIs 1502e. If the topology exposure and inventory management component 1102 maintains a database of actual site and hardware, the topology exposure and inventory management component 1102 may fulfill digital twin specifications by providing a TRU layout based on geographical region input. The topology exposure and inventory management component 1102 may also generate a placement hypothesis for non-existent site locations when, for example, performing green field network planning.

Network topology management techniques may be performed by the topology exposure and inventory management component 1102, and configuration management techniques may be performed by the RAN NF CM component 1002. An rApp may monitor RAN NF PM, FM, or CM data and configurations to initiate digital twin-based modeling for a configuration or scenario. Additionally, digital twin related rApps may have access to all functions and data supported by the SMO 502. The SMO 502 may additionally include a use-case specific orchestrator rApp for processes such as coverage optimization, capacity estimation, energy saving, network slice feasibility evaluation, and load balancing. The rApp implementations may run in a loop to more consistently predict real world behavior.

The implementation illustrated with respect to FIGS. 16A and 16B affects baseline SMO components. For example, the service management and exposure component 1412 may perform techniques based on indications from a registry component. Digital twin related services, both internal and external, may be registered with the service management and exposure component 1412. The RAN NF CM component 1002 defines specifications as part of a configuration model management component. Additionally, the RAN NF CM component 1002 supports additional functionality for providing notifications to a registered subscriber when a RAN configuration change occurs. The RAN NF FM component 1420 supports additional functionality for notifying a registered subscriber based on receiving a fault indication or monitored alarm indication. The RAN NF PM component 1422 supports additional functionality for providing performance reports, trace logs, and subscriber device location information. The topology exposure and inventory management component 1102 provides cellular site location layout information based on geographical region input or a generating placement hypothesis for non-existent cellular site locations.

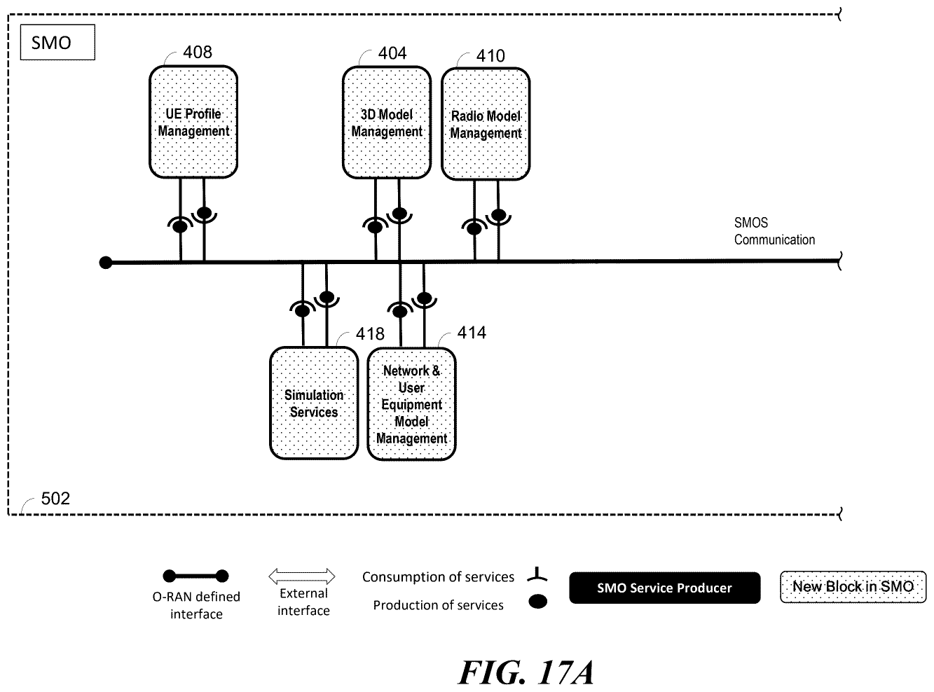

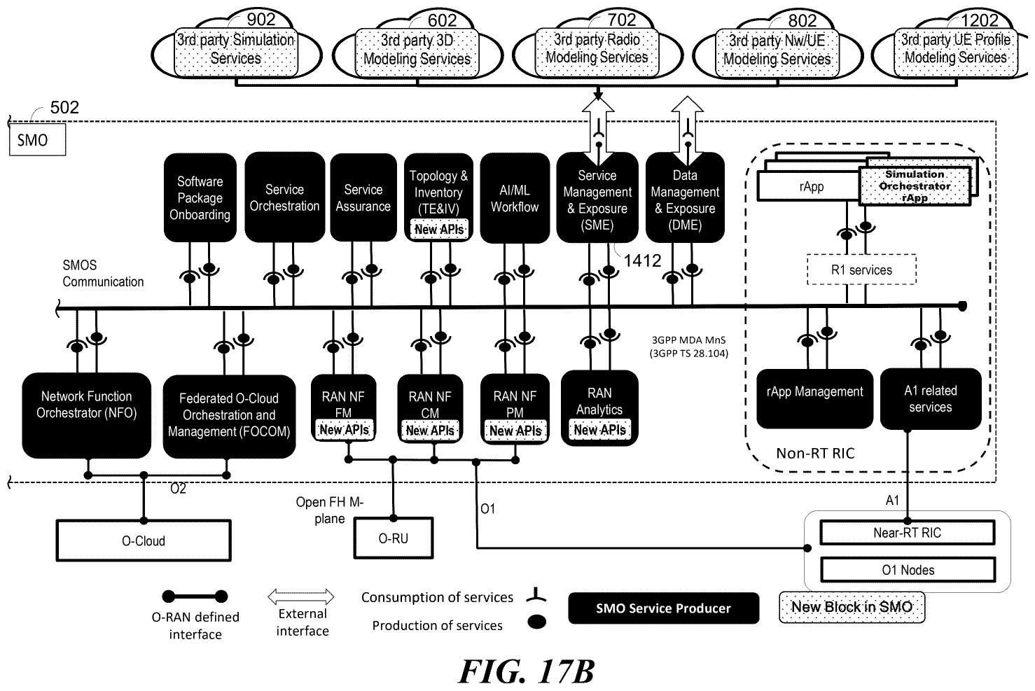

FIGS. 17A and 17B illustrate a DTaaS third-party foundation architecture implementation, in accordance with aspects of the present disclosure. For ease of viewing, the DTaaS third-party foundation architecture implementation is divided into two separate figures, FIGS. 17A and 17B. As shown in FIGS. 17A and 17B, the service management and exposure component 1412 is in communication with third-party simulation services 902, third-party 3D modeling services 602, third-party radio modeling services 702, third-party network and UE modeling services 802, and third-party UE profile model services 1202. As shown in FIGS. 17A and 17B, some foundation components and services are hosted externally by, for example, third-party platforms. The UE profile model management component 408, 3D model management component 404, radio model management component 410, simulation services component 418, and network and UE model management component 414 may provide additional services by implementing the third-party components, may act as an intermediary for the SMO 502, or may be absent from the SMO 502.

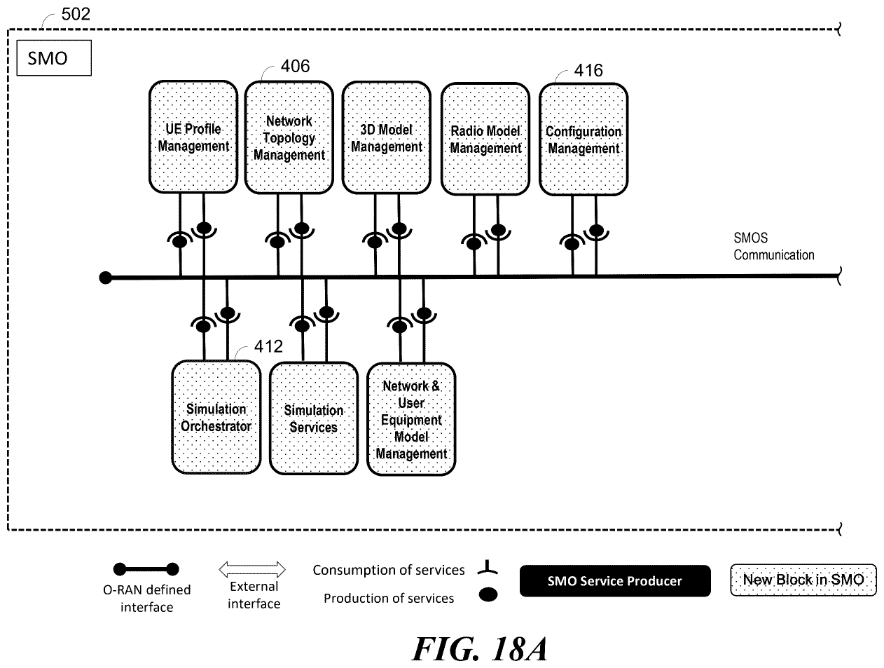

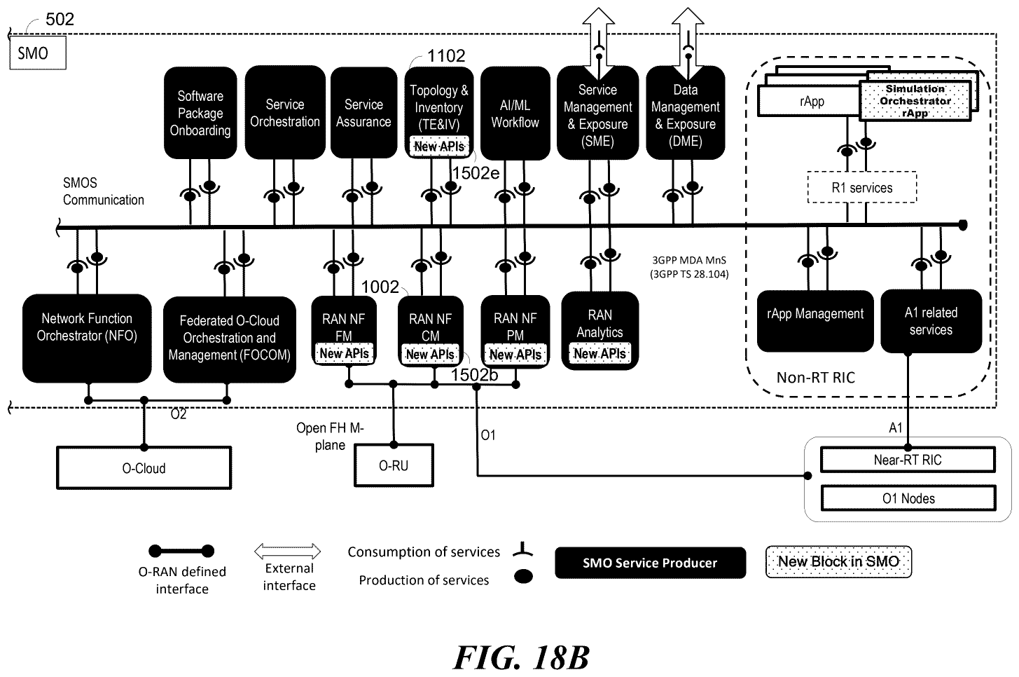

FIGS. 18A and 18B illustrate a DTaaS foundation and orchestrator architecture implementation, in accordance with aspects of the present disclosure. For ease of viewing, the DTaaS foundation and orchestrator architecture implementation is divided into two separate figures, FIGS. 18A and 18B. As shown in FIGS. 18A and 18B, the SMO 502 includes the simulation orchestrator component 412. Use-case improvement and analysis functionality may be implemented by the simulation orchestrator component 412. An rApp may monitor RAN NF PM, FM, and CM data and configurations, and trigger digital twin-based modeling of a configuration or scenario with recipes available in the simulation orchestrator component 412. Digital twin related rApps may have access to some components and data supported by the SMO 502. The SMO 502 may additionally implement use-case specific orchestrator recipes for coverage optimization, capacity estimation, energy saving, network slice feasibility evaluation, and load balancing, for example.

In some implementations, the SMO 502 only includes either the network topology management component 406 or the new APIs 1502e for generating multiple hypotheses of site locations and hardware in the topology exposure and inventory management component 1102. Similarly, the SMO 502 may only include one of the configuration management component 416 or the new APIs 1502b for pre-defined or experimental configuration generation in the RAN NF CM component 1002.

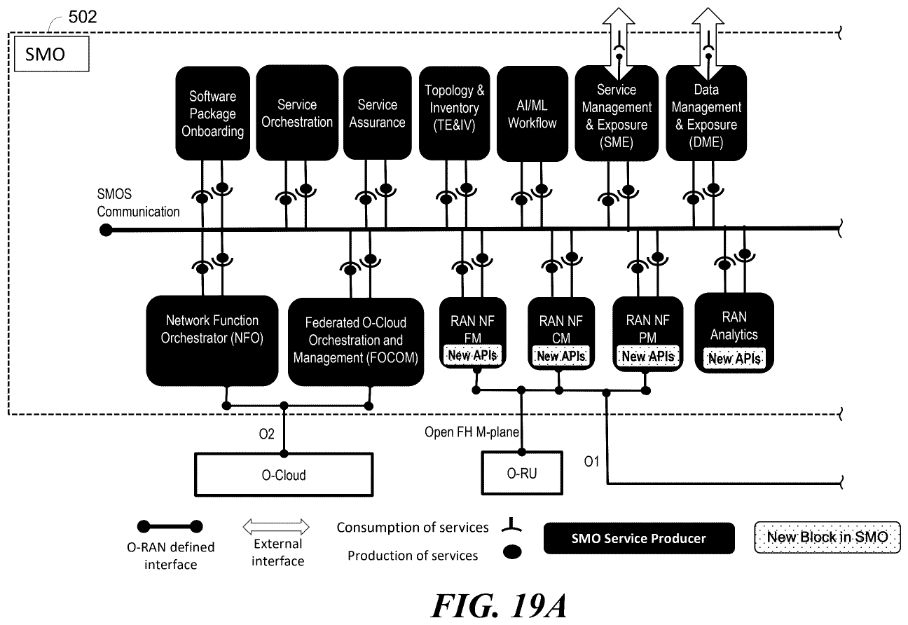

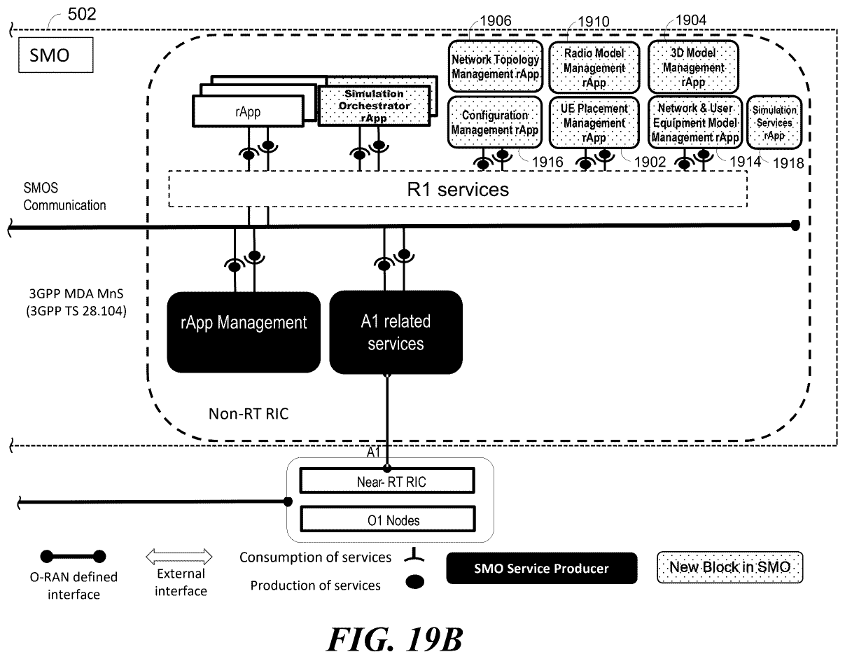

FIGS. 19A and 19B illustrate a DTaaS rApp architecture implementation, in accordance with aspects of the present disclosure. For ease of viewing, the DTaaS rApp architecture implementation is divided into two separate figures, FIGS. 19A and 19B. As shown in in FIGS. 19A and 19B, various new components are provided as rApps in an application domain. A UE placement management rAPP 1902 plans UE locations within a network based on input information. A 3D model management rAPP 1904 performs the same or similar techniques as the 3D model management component 404.

A network topology management rAPP 1906 performs the same or similar techniques as the network topology management component 406. Additionally, the network topology management rAPP 1906 may internally implement topology exposure and inventory management services to receive or transmit actual site locations and hardware information. A radio model management rAPP 1910 performs the same or similar techniques as the radio model management component 410. A network and UE model management rAPP 1914 performs the same or similar techniques as the network and UE model management component 414. A configuration management rAPP 1916 performs the same or similar techniques as the configuration management component 416. Additionally, the configuration management rAPP 1916 may internally implement RAN NF CM services to receive or transmit actual configuration information. A simulation services rAPP 1918 performs the same or similar techniques as the simulation services component 418. In some examples, a single digital twin rApp is configured to perform the same techniques as one or more of the simulation orchestrator rAPP 1504, UE placement management rAPP 1902, 3D model management rAPP 1904, network topology management rAPP 1906, radio model management rAPP 1910, network and UE model management rAPP 1914, configuration management rAPP 1916, and/or simulation services rAPP 1918.

As shown in FIGS. 19A and 19B, all foundation components may be implemented as rApps. Use-case specific improvement and analysis functionality may also be implemented by rApps. Additionally, rApps may monitor RAN NF PM, FM, and CM data and configurations and trigger digital twin-based modeling of a configuration or scenario. Digital twin related rApps may have access to all components and data supported by the SMO 502. A use-case specific orchestrator rApp may perform various techniques such as coverage optimization, capacity estimation, energy saving, network slice feasibility evaluation, and load balancing. The SMO 502 may additionally implement external or third-party hosted services (not illustrated).

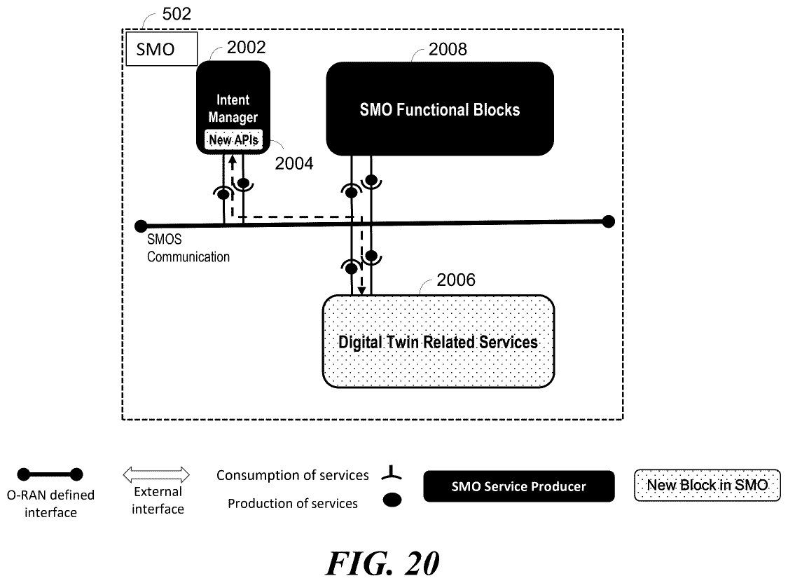

FIG. 20 illustrates a DTaaS architecture with an intent manager component, in accordance with aspects of the present disclosure. As shown in FIG. 20, the SMO 502 includes an intent manager 2002 that implements new APIs 2004. The intent manager 2002 supports components and services for providing intent as an input to a digital twin. The new APIs 2004 may enable the intent manager 2002 to interface with other components, such as SMO functional blocks 2008. The intent manager 2002 may also communicate with digital twin related services 2006. The digital twin related services 2006 may be the same or similar services as the digital twin related services within the SMO 504, or, in some implementations, the third-party digital twin related services 506. The SMO functional blocks 2008 may be any combination of baseline SMO components, such as the service assurance component 1408 or the RAN analytics component 1424.

FIG. 21 is a timing diagram illustrating a first portion of a recipe for coverage improvement, in accordance with aspects of the present disclosure. The recipe for coverage improvement may also be referred to as a recipe for coverage optimization, or a fill coverage gap recipe. For FIGS. 21, 22, and 23, if a fault triggers and/or some TRU sites are down, the recipe for coverage improvement may be implemented to fill coverage gaps. As shown in FIG. 21, at time t1, a subscribe indication, including an NF identification and alarm types, transmits from the network topology management component 406 to the RAN NF FM component 1420. At time t2, the RAN NF FM component 1420 registers a consumer for notifications. At time t3, a subscribe response, including a subscription identification, transmits from the RAN NF FM component 1420 to the network topology management component 406. At time t4, the recipe is activated. A subscribe indication, including an rApp identification and alarm types, transmits from the simulation orchestrator rAPP 1504 to the RAN NF FM component 1420. At time t5, the RAN NF FM component 1420 registers a consumer for notifications. At time t6, a subscribe response transmits from the RAN NF FM component 1420 to the simulation orchestrator rAPP 1504.

At time t7, a fault indication transmits from a hardware component (not illustrated) to the RAN NF FM component 1420. The fault indication may be a result of a hardware failure in the field (RAN). For example, the fault indication may transmit if a cellular site is down due to an equipment fault. At time t8, the RAN NF FM component 1420 sends notifications to a registered consumer. At time t9, a notification indication, including subscription identification and fault details, transmits from the RAN NF FM component 1420 to the simulation orchestrator rAPP 1504. At time t10, a notification indication, including subscription identification and fault details, transmits from the RAN NF FM component 1420 to the network topology management component 406. The simulation orchestrator rAPP 1504 may initiate analysis for finding an improved configuration for minimizing a coverage gap. The network topology management component 406 may update impacted site information. At time t11, a model request, including parameters, transmits from the simulation orchestrator rAPP 1504 to the 3D model management component 404.

At time t12, the 3D model management component 404 retrieves a 3D model of a requested region. At time t13, a model response, including a 3D model, transmits from the 3D model management component 404 to the simulation orchestrator rAPP 1504. At time t14, a model request, including parameters, transmits from the simulation orchestrator rAPP 1504 to the network topology management component 406. At time t15, the network topology management component retrieves a TRU layout model for a requested region. The TRU layout may be generated without faulty TRUs. At time t16, a model response, including one or more layout models, transmits from the network topology management component 406 to the simulation orchestrator rAPP 1504.

FIG. 22 is a timing diagram illustrating a second portion of the recipe for coverage improvement, in accordance with aspects of the present disclosure. The timing diagram of FIG. 22 may be a continuation of the techniques illustrated by the timing diagram of FIG. 21. At time t17, the step A, the simulation orchestrator rAPP 1504 selects a TRU layout model. Multiple iterations of step A may be completed depending on an objective. At time t18, a location model request, including parameters, transmits from the simulation orchestrator rAPP 1504 to the UE profile model management component 408. For example, crowd sourced date may be retrieved. At time t19, the UE profile model management component 408 retrieves a UE location model for a requested region. At time t20, a location model response, including one or more layout models, transmits from the UE profile model management component 408 to the simulation orchestrator rAPP 1504. At time t21, the simulation orchestrator rAPP 1504 selects a UE layout model and an antenna type and orientation. The simulation orchestrator rAPP 1504 may complete multiple iterations for antenna tilt, beam shape, and direction configuration. At time t22, a radio model request, including parameters, transmits from the simulation orchestrator rAPP 1504 to the radio model management component 410.

At time t23, the radio model management component 410 retrieves and/or generates a radio model based on the radio model request. At time t24, a radio model response, including a model, transmits from the radio model management component 410 to the simulation orchestrator rAPP 1504. At time t25, a get request, including parameters, transmits from the simulation orchestrator rAPP 1504 to the configuration management component 416. At time t26, the configuration management component 416 reads a TRU and/or base station (e.g., gNB) configuration from a database. At time t27, a get response, including a configuration model, transmits from the configuration management component 416 to the simulation orchestrator rAPP 1504. At time t28, a model request, including parameters, transmits from the simulation orchestrator rApp 1504 to the network and UE model management component 414. At time t29, the network and UE model management component 414 retrieves models for a requested type of model. At time t30, a model response, including network and UE models, transmits from the network and UE model management component 414 to the simulation orchestrator rAPP 1504.

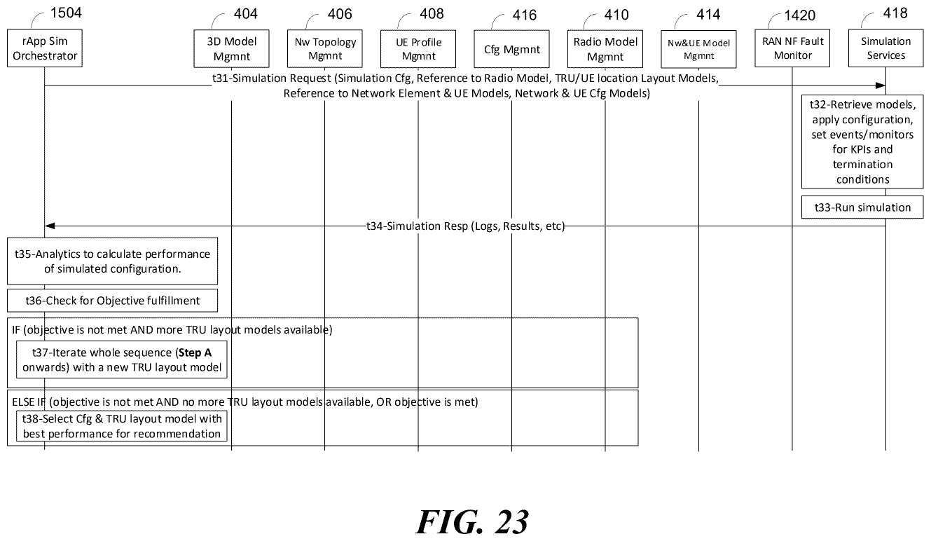

FIG. 23 is a timing diagram illustrating a third portion of the recipe for coverage improvement, in accordance with aspects of the present disclosure. The timing diagram of FIG. 23 may be a continuation of the techniques illustrated by the timing diagram of FIGS. 21 and 22. For example, the timing diagrams of FIGS. 21, 22, and 23 may be performed in a sequence. At time t31, a simulation request, including simulation configuration, radio model reference, TRU/UE location layout models, network element and UE models reference, and network and UE configuration models, transmits from the simulation orchestrator rAPP 1504 to the simulation services component 418. At time t32, the simulation services component 418 retrieves models, applies configurations, sets events, and monitors for key performance indicators (KPIs) and termination conditions. At time t33, the simulation services component 418 runs a simulation. At time t34, a simulation response, including logs and results, transmits from the simulation services component 418 to the simulation orchestrator rAPP 1504.

At time t35, the simulation orchestrator rAPP 1504 performs analytics to calculate the performance of the simulated configuration. For example, the simulation orchestrator rAPP 1504 may perform a cumulative distribution function (CDF) based on a reference signal received power (RSRP) across all receiver locations. At time t36, the simulation orchestrator rAPP 1504 checks for objective fulfillment. For example, the simulation orchestrator rAPP 1504 may check if the ninety-ninth percentile of the RSRP CDF is better than an out-of-service threshold. At time t37, if an objective is not met and more TRU layout models are available, the simulation orchestrator rAPP 1504 iterates a new sequence, from step A onwards, with a new TRU layout model. At time t38, if an objective is not met and no more TRU layout models are available, or if an objective is met, the simulation orchestrator rAPP 1504 selects a configuration and TRU layout model with a best performance for recommendation. Existing SMO components can then deploy the solution to the network.

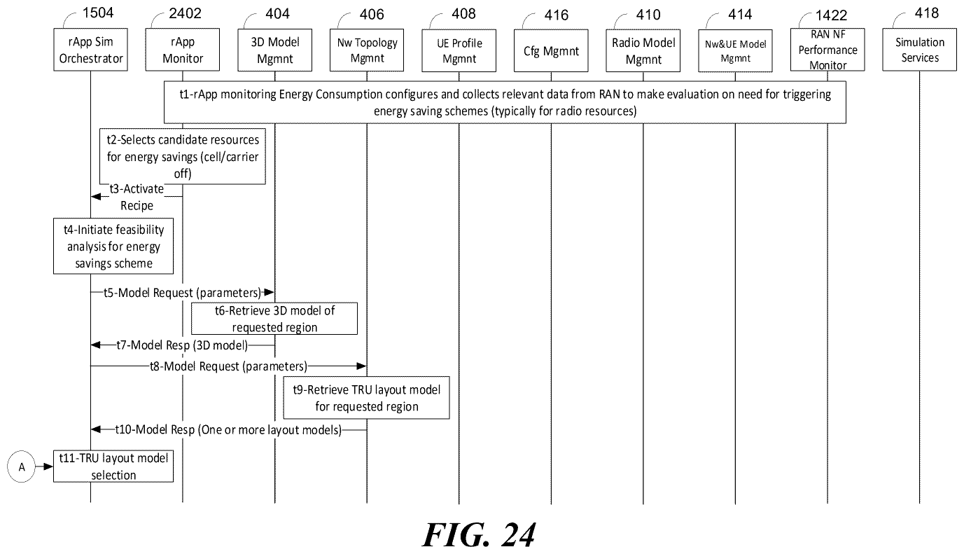

FIG. 24 is a timing diagram illustrating a first portion of a recipe for energy saving, in accordance with aspects of the present disclosure. At time t1, the rApp monitor 2402 monitors energy consumption configurations and collects relevant data from the RAN to make an evaluation regarding triggering energy saving techniques, such as for radio resources. At time t2, the rApp monitor 2402 selects candidate resources for energy savings. The rApp monitor 2402 may combine historical and performance data with AI or ML models. At time t3, an active recipe indication transmits from the rApp monitor 2402 to the simulation orchestrator rAPP 1504. The activate recipe indication may cause a digital twin rApp to analyze the impact of a selected cell, carrier, or antenna array being on or off to assess the impact on QoS and QoE. The input for the rApp analysis may include information such as a region, resources to be switched off, expected traffic model, and device density. At time t4, the simulation orchestrator rAPP 1504 initiates a feasibility analysis for an energy saving technique. At time t5, a model request, including parameters, transmits from the simulation orchestrator rAPP 1504 to the 3D model management component 404. At time t6, the 3D model management component 404 retrieves a 3D model of a requested region.

At time t7, a model response, including a 3D model, transmits from the 3D model management component 404 to the simulation orchestrator rAPP 1504. At time t8, a model request, including parameters, transmits from a simulation orchestrator rAPP 1504 to the network topology management component 406. Input parameters may include information such as a region and/or resources to be switched off. At time t9, the network topology management component retrieves a TRU layout model for a requested region. The layout model may have been generated without switched-off TRUs. At time t10, a model response, including one or more layout models, transmits from the network topology management component 406 to the simulation orchestrator rAPP 1504. At time t11, which may be the beginning of a step A, the simulation orchestrator rAPP 1504 selects a TRU layout model. Multiple iterations of step A may be performed depending on an objective.

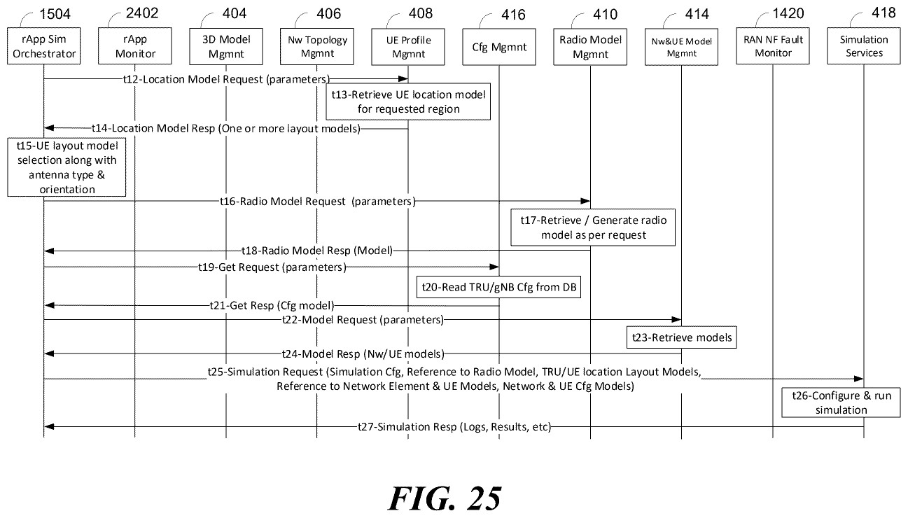

FIG. 25 is a timing diagram illustrating a second portion of the recipe for energy saving, in accordance with aspects of the present disclosure. The timing diagram of FIG. 25 may be a continuation of the techniques illustrated by the timing diagram of FIG. 24. At time t12, a location model request may be transmitted from the simulation orchestrator rAPP 1504 to the UE profile model management component 408. The parameter inputs may include a region, expected traffic model, and device density. At time t13, the UE profile model management component 408 retrieves a UE location model for a requested region. One of the subscriber models may also be the exact set of subscribers in the field that are planned to be offloaded to other cells or carriers as part of an energy saving deployment. At time t14, a location model response, including one or more layout models, transmits from the UE profile model management component 408 to the simulation orchestrator rAPP 1504. At time t15, the simulation orchestrator rAPP 1504 selects a UE layout model along with an antenna type and orientation. Multiple selections may be performed for different subscriber placement and mobility.

At time t16, a radio model request, including parameters, transmits from the simulation orchestrator rAPP 1504 to the radio model management component 410. At time t17, the radio model management component 410 retrieves or generates a radio model based on the model request. At time t18, a radio model response, including a model, transmits from the radio model management component 410 to the simulation orchestrator rAPP 1504. At time t19, a get request, including parameters, transmits from the simulation orchestrator rAPP 1504 to the configuration management component 416. At time t20, the configuration management component 416 reads TRU or gNB configurations from a database. At time t21, a get response, including a configuration model, transmits from the configuration management component 416 to the simulation orchestrator rAPP 1504. At time t22, a model request, including parameters, transmits from the simulation orchestrator rAPP 1504 to the network and UE model management component 414. At time t23, the network and UE model management component 414 retrieves models.

At time t24, a model response, including network and UE models, transmits from the network and UE model management component 414 to the simulation orchestrator rAPP 1504. At time t25, a simulation request, including a simulation configuration, radio model reference, TRU/UE location layout models, network element and UE models reference, and network and UE configuration models, transmits from the simulation orchestrator rAPP 1504 to the simulation services component 418. At time t26, the simulation services component 418 configures and runs a simulation. Subscriber populations may be distributed to active cells or carriers. At time t27, a simulation response, including information such as logs and results, transmits from the simulation services component 418 to the simulation orchestrator rAPP 1504.

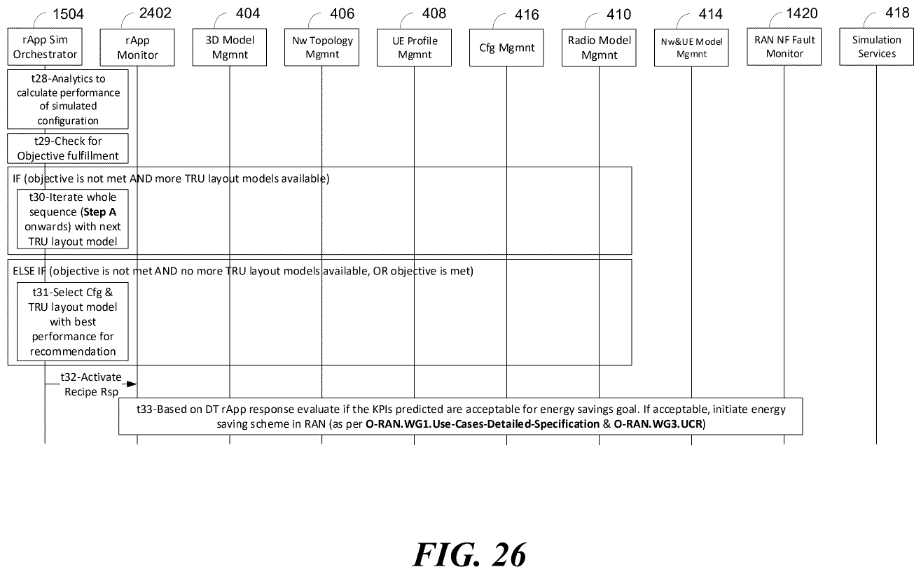

FIG. 26 is a timing diagram illustrating a third portion of the recipe for energy saving, in accordance with aspects of the present disclosure. The timing diagram of FIG. 26 may be a continuation of the techniques illustrated by the timing diagram of FIGS. 24 and 25. For example, the timing diagrams of FIGS. 24, 25, and 26 may be performed in a sequence. In FIGS. 24, 25, and 26, an energy consumption monitoring rApp identifies resources to switch on or off, and initiates what-if analysis on QoS/QoE impacts, where some TRU sites/carriers/antennas are off. An objective may be to evaluate impact on QoS or QoE and/or recommend other configuration adjustments to reduce or minimize the impact. At time t28, the simulation orchestrator rAPP 1504 performs analytics to calculate the performance of a simulated configuration. For example, the simulation orchestrator rAPP 1504 may perform a cumulative distribution function based on a reference signal received power (RSRP) indicator across all receiver locations, or a cumulative distribution function based on a throughput across all receiver locations.

At time t29, the simulation orchestrator rAPP 1504 checks for objective fulfillment. For example, the simulation orchestrator rAPP 1504 may check if the ninety-ninth percentile of the RSRP cumulative distribution function (CDF) is better than an out-of-service threshold, and if the ninety-ninth percentile of throughput and end-to-end latency is better than specified QoS and QoE thresholds. At time t30, if the objective is not met AND more TRU layout models are available, the simulation orchestrator rAPP 1504 iterates through a sequence of step A onwards with a next TRU layout model. At time t31, if the objective is not met and no more TRU layout models are available, or the objective is met, the simulation orchestrator rAPP 1504 selects a configuration and TRU layout model with best performance for recommendation. At time t32, a recipe response activation indication transmits from the simulation orchestrator rAPP 1504 to the rApp monitor 2402. At time t33, based on the digital twin rApp response, the rApp monitor 2402 evaluates if the key performance indicators predicted are acceptable for an energy savings goal. If the key performance indicators satisfy an energy saving threshold, the rApp monitor 2402 initiates energy saving techniques in RAN.

As discussed, various aspects of the present disclosure are directed to wireless network digital twin techniques. These techniques include a 3D model management technique, a UE profile model management technique, a radio model management technique, a network and user equipment model management technique, a network topology model management technique, a configuration model management technique, a simulation services technique, a simulation orchestrator technique, and a registry technique. Each technique may be performed by respective components illustrated and described with respect to the various figures of the disclosure. A component may interact with another component as well as external sources by implementing registry techniques. Digital twin foundation techniques may be implemented as part of an O-RAN SMO. Components may be implemented as a part of an SMO platform and/or as rApps.

O-RAN service management and exposure may be implemented for registering digital twin related services. All digital twin related services may be hosted by external or third-party platforms and may also be registered. All registered services may be discoverable. O-RAN topology exposure and inventory management may support techniques for generating cellular site location layouts and type of hardware resources installed for a digital twin. The techniques may include creating a layout model of a TRU placement, either commissioned-active or commissioned-not active, based on a given criteria, such as geographical region, type of hardware, access technology, and TRUs to be removed or disabled. The techniques may be useful for creating layouts with removed, disabled, faulty, or energy-saving candidates. The techniques may be implemented to create a layout model of new/non-existing TRU placement layout sets based on a given criteria, e.g., in green field planning. The techniques may support specifications of providing a cellular site location layout based on geographical region input or generating a placement hypothesis for non-existent cellular site locations.

The O-RAN NF CM supports techniques for generating a network configuration for a digital twin from stored or pre-defined configurations. The O-RAN NF CM supports techniques for providing a snapshot of an active RAN configuration from a physical world network and providing the snapshot for the digital twin. The O-RAN NF CM also supports additional techniques for providing a notification to registered digital twin subscriber components whenever there is a RAN configuration change in a physical world network. An O-RAN NF PM supports techniques for providing performance reports, trace logs, and user device location information. An O-RAN NF FM supports techniques for providing a notification to registered digital twin subscribers whenever there is a fault or a monitored alarm fire. An SMO intent manager may support techniques for providing intent as input for a digital twin. Additionally, models of a digital twin may be stored in an AI or ML workflow service of the SMO.

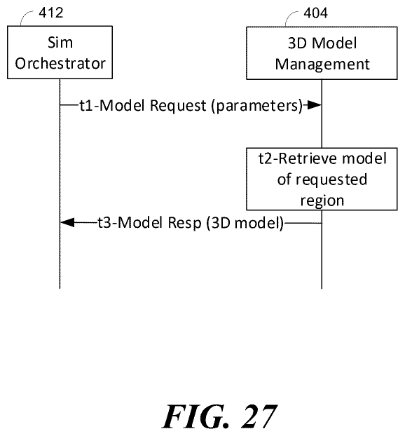

FIG. 27 is a timing diagram illustrating a 3D model retrieval technique, in accordance with aspects of the present disclosure. At time t1, a model request, including parameters, transmits from the simulation orchestrator component 412 to the 3D model management component 404. At time t2, the 3D model management component 404 retrieves a model of a requested region. At time t3, a model response, including a 3D model, transmits from the 3D model management component 404 to the simulation orchestrator component 412.

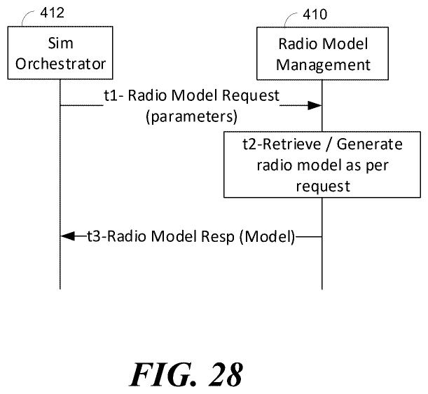

FIG. 28 is a timing diagram illustrating a technique for generating a radio model, in accordance with aspects of the present disclosure. At time t1, a radio model request, including parameters, transmits from the simulation orchestrator component 412 to the radio model management component 410. The radio model management component 410 may also be referred to as a radio modeling component. At time t2, the radio model management component 410 retrieves and/or generates a radio model based on the request. At time t3, a radio model response, including a model, transmits from the radio model management component 410 to the simulation orchestrator component 412.

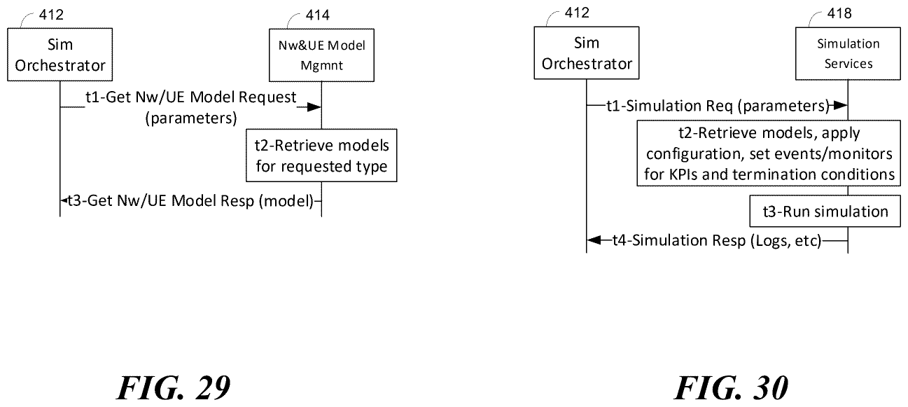

FIG. 29 is a timing diagram illustrating a technique for retrieving a network or UE behavior model, in accordance with aspects of the present disclosure. At time t1, a get network and/or UE model request, including parameters, transmits from the simulation orchestrator component 412 to the network and UE model management component 414. At time t2, the network and UE model management component 414 retrieves models for a requested type. At time t3, a get network and/or model response, including a model, transmits from the network and UE model management component 414 to the simulation orchestrator component 412.

FIG. 30 is a timing diagram illustrating a technique for running a simulation, in accordance with aspects of the present disclosure. At time t1, a simulation request, including parameters, transmits from the simulation orchestrator component 412 to the simulation services component 418. At time t2, the simulation services component 418 retrieves models, applies a configuration, sets events, and monitors for key performance indicators and termination conditions. At time t3, the simulation services component 418 performs a simulation. At time t4, a simulation response, including logs and other information, transmits from the simulation services component 418 to the simulation orchestrator component 412.

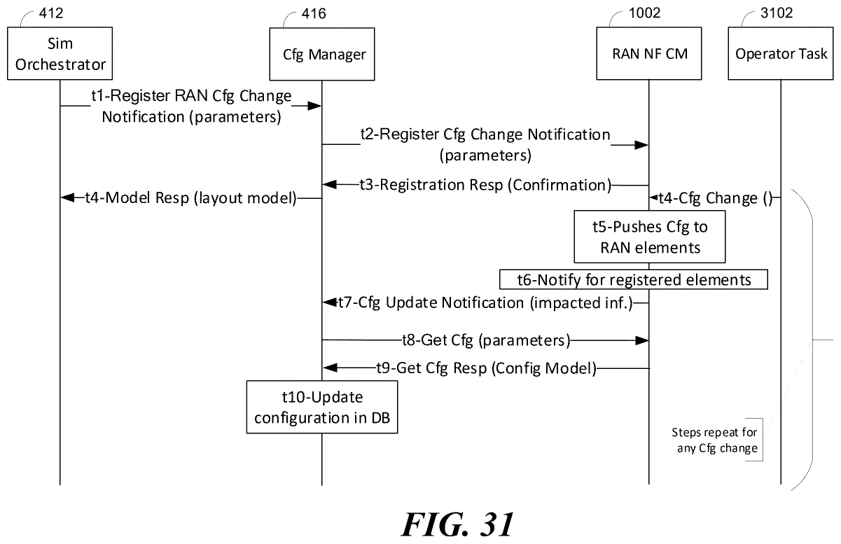

FIG. 31 is a timing diagram illustrating a network configuration change monitoring technique, in accordance with aspects of the present disclosure. At time t1, a register RAN configuration change notification, including parameters, transmits from the simulation orchestrator component 412 to the configuration management component 416. At time t2, a register configuration change notification, including parameters, transmits from the configuration management component 416 to the RAN NF CM component 1002. The configuration management component 416 may also be referred to as a network configuration manager. At time t3, a registration response, including a confirmation, transmits from the RAN NF CM component 1002 to the configuration management component 416. At time t4, a configuration change transmits from an operator task component 3102 to the RAN NF CM component 1002. The operator task component 3102 may be a component configured to manage, maintain, or improve RAN infrastructure.

Additionally, at time t4, a model response, including a layout model, transmits from the configuration management component 416 to the simulation orchestrator component 412. At time t5, the RAN NF CM component 1002 pushes a configuration to RAN elements. At time t6, the RAN NF CM component 1002 notifies for registered elements. At time t7, a configuration update notification, including impacted infrastructure, transmits from the RAN NF CM component 1002 to the configuration management component 416. At time t8, a get configuration indication, including parameters, transmits from the configuration management component 416 to the RAN NF CM component 1002. At time t9, a get configuration response, including a configuration model, transmits from the RAN NF CM component 1002 to the configuration management component 416. At time t10, the configuration management component 416 updates a configuration in a database. Times t4 to t10 may repeat for any configuration change.

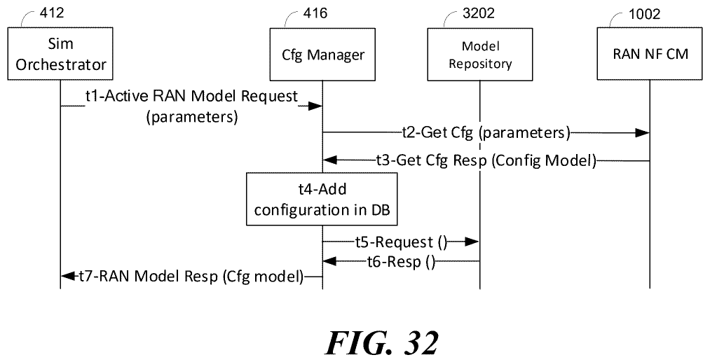

FIG. 32 is a timing diagram illustrating an active network configuration model retrieval technique, in accordance with aspects of the present disclosure. At time t1, an activate RAN model request, including parameters, transmits from the simulation orchestrator component 412 to the configuration management component 416. At time t2, a get configuration indication, including parameters, transmits from the configuration management component 416 to the RAN NF CM component 1002. At time t3, a get configuration response, including a configuration model, transmits from the RAN NF CM component 1002 to the configuration management component 416. At time t4, the configuration management component 416 adds a configuration to a database. At time t5, a request transmits from the configuration management component 416 to a model repository 3202. The model repository 3202 may upload or download information from a database. At time t6, a response transmits from the model repository 3202 to the configuration management component 416. At time t7, a RAN model response, including a configuration model, transmits from the configuration management component 416 to the simulation orchestrator component 412.

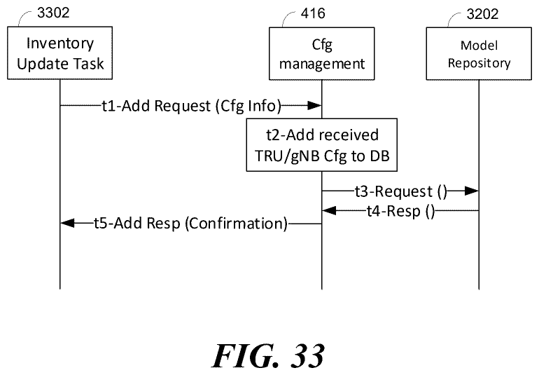

FIG. 33 is a timing diagram illustrating a network or UE configuration model addition technique, in accordance with aspects of the present disclosure. At time t1, an inventory update task component 3302 transmits an add request, including configuration information, to the configuration management component 416. The inventory update task component 3302 may be configured to facilitate updating inventory records to reflect changes in RAN equipment or configurations. At time t2, the configuration management component 416 adds a received TRU and/or base station (e.g., gNB) configuration to a database. At time t3, a request transmits from the configuration management component 416 to the model repository 3202. At time t4, a response transmits from the model repository 3202 to the configuration management component 416. At time t5, an add response, including a confirmation transmits from the configuration management component 416 to the inventory update task component 3302.

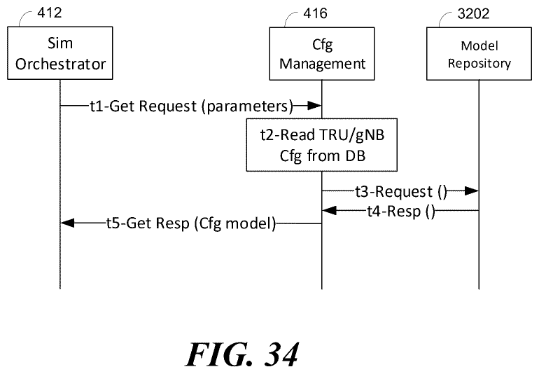

FIG. 34 is a timing diagram illustrating network or UE configuration model retrieval technique, in accordance with aspects of the present disclosure. At time t1, a get request, including parameters, transmits from the simulation orchestrator component 412 to the configuration management component 416. At time t2, the configuration management component 416 reads a TRU or gNB configuration from a database. At time t3, a request transmits from the configuration management component 416 to the model repository 3202. At time t4, a response transmits from the model repository 3202 to the configuration management component 416. At time t5, a get response, including a configuration model, transmits from the configuration management component 416 to the simulation orchestrator component 412.

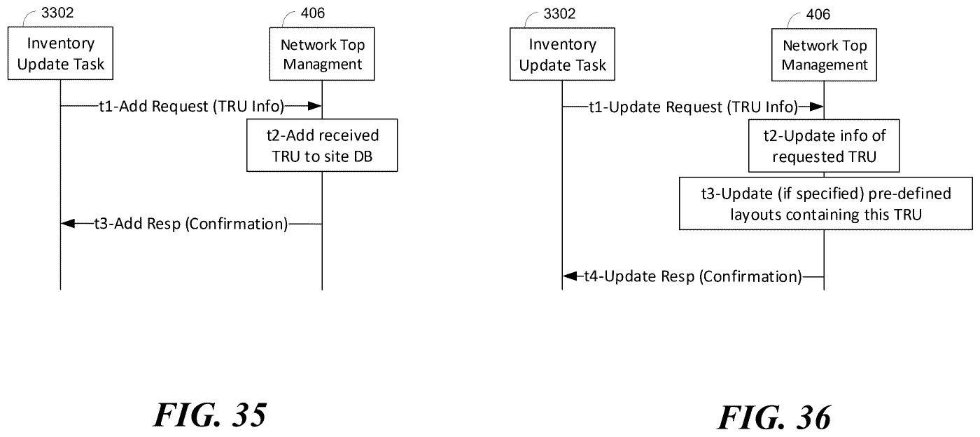

FIG. 35 is a timing diagram illustrating a TRU information addition technique, in accordance with aspects of the present disclosure. At time t1, an add request, including TRU information, transmits from the inventory update task component 3302 to the network topology management component 406. The network topology management component 406 may also be referred to as a TRU location manager. At time t2, the network topology management component 406 adds a received TRU to a site database. At time t3, an add response, including a confirmation, transmits from the network topology management component 406 to the inventory update task component 3302.

FIG. 36 is a timing diagram illustrating a TRU information update technique, in accordance with aspects of the present disclosure. At time t1, an update request, including TRU information, transmits from an inventory update task component 3302 to a network topology management component 406. At time t2, the network topology management component 406 updates the information of a requested TRU. At time t3, if specified, the network topology management component 406 updates pre-defined layouts containing the TRU. At time t4, an update response, including confirmation, transmits from the network topology management component 406 to the inventory update task component 3302.

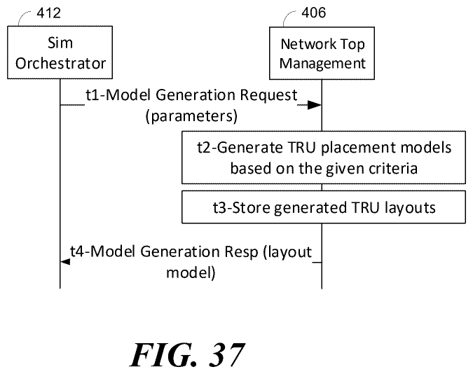

FIG. 37 is a timing diagram illustrating a TRU layout model generation technique, in accordance with aspects of the present disclosure. At time t1, a model generation request, including parameters, transmits from the simulation orchestrator component 412 to the network topology management component 406. At time t2, the network topology management component 406 generates TRU placement models based on a given criteria. At time t3, the network topology management component 406 stores generated TRU layouts. At time t4, a model generation response, including a layout model, transmits from the network topology management component 406 to the simulation orchestrator component 412.

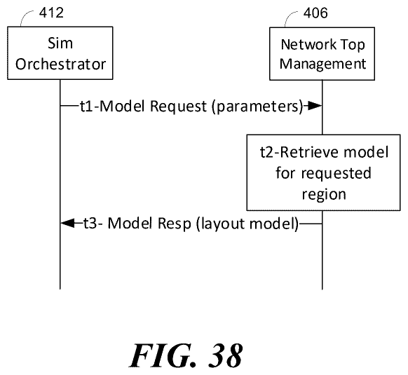

FIG. 38 is a timing diagram illustrating a TRU layout model retrieval technique, in accordance with aspects of the present disclosure. At time t1, a model request, including parameters, transmits from the simulation orchestrator component 412 to the network topology management component 406. At time t2, the network topology management component 406 retrieves a model for a requested region. At time t3, a model response, including a layout model, transmits from the network topology management component 406 to the simulation orchestrator component 412.

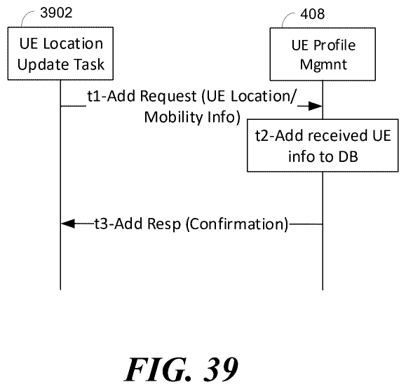

FIG. 39 is a timing diagram illustrating a UE location and mobility information addition technique, in accordance with aspects of the present disclosure. At time t1, an add request, including a UE location and mobility information, transmits from a UE location update task component 3902 to the UE profile model management component 408. At time t2, the UE profile model management component 408 adds the received UE information to a database. At time t3, an add response, including a confirmation, transmits from the UE profile model management component 408 to the UE location update task component 3902.

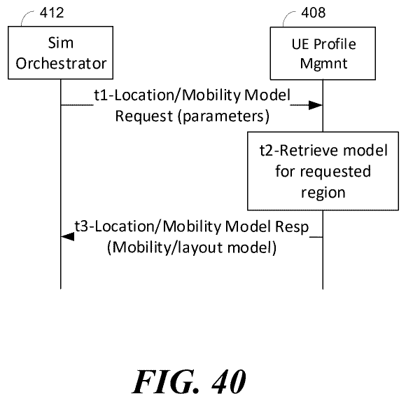

FIG. 40 is a timing diagram illustrating a UE layout model retrieval technique, in accordance with aspects of the present disclosure. At time t1, a location and/or mobility model request, including parameters, transmits from the simulation orchestrator component 412 to the UE profile model management component 408. At time t2, the UE profile model management component 408 retrieves a model for a requested region. At time t3, a location and/or mobility model response, including a mobility and/or layout model, transmits from the UE profile model management component 408 to the simulation orchestrator component 412.

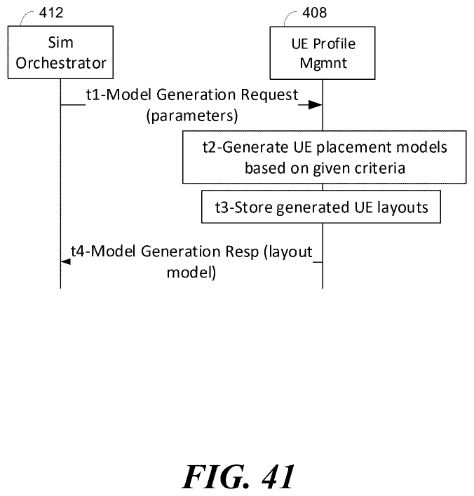

FIG. 41 is a timing diagram illustrating a UE layout model generation technique, in accordance with aspects of the present disclosure. At time t1, a model generation request, including parameters, transmits from the simulation orchestrator component 412 to the UE profile model management component 408. At time t2, the UE profile model management component 408 generates UE placement models based on given criteria. At time t3, the UE profile model management component 408 stores generated UE layouts. At time t4, a model generation response, including a layout model, transmits from the UE profile model management component 408 to the simulation orchestrator component 412.

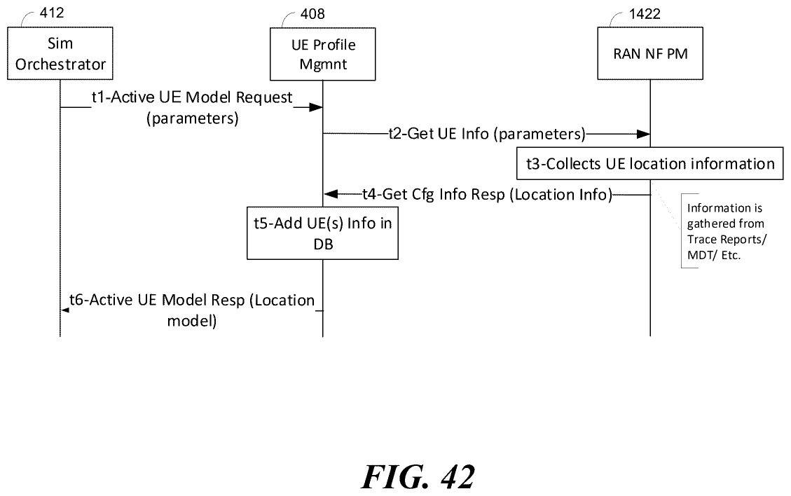

FIG. 42 is a timing diagram illustrating an active UE location model retrieval technique, in accordance with aspects of the present disclosure. At time t1, an activate UE model request, including parameters, transmits from the simulation orchestrator component 412 to the UE profile model management component 408. At time t2, a get UE information request, including parameters, transmits from the UE profile model management component 408 to the RAN NF PM component 1422. At time t3, the RAN NF PM component 1422, collects UE location information. The location information may be gathered from trace reports and minimization of drive tests (MDTs). At time t4, a get configuration information response, including location information, transmits from the RAN NF PM component 1422 to the UE profile model management component 408. At time t5, the UE profile model management component 408 adds UE information to a database. At time t6, an active UE model response, including a location model, transmits from the UE profile model management component 408 to the simulation orchestrator component 412.

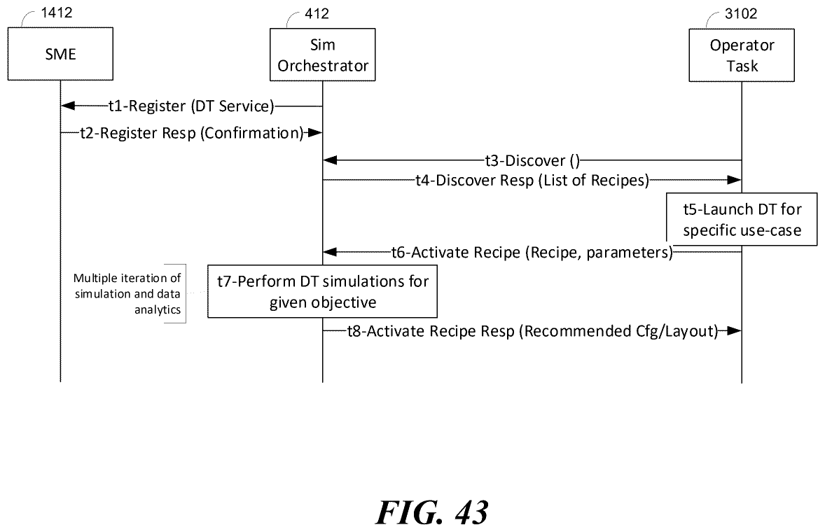

FIG. 43 is a timing diagram illustrating a service registration and activation technique, in accordance with aspects of the present disclosure. At time t1, a register indication, including a digital twin service, transmits from the simulation orchestrator component 412 to the service management and exposure component 1412. At time t2, a register response, including a confirmation, transmits from the service management and exposure component 1412 to the simulation orchestrator component 412. At time t3, a discover indication transmits from the operator task component 3102 to the simulation orchestrator component 412. At time t4, a discover response, including a list of recipes, transmits from the simulation orchestrator component 412 to the operator task component 3102. At time t5, the operator task component 3102 launches a digital twin for a specific use-case. At time t6, an activate recipe indication, including a recipe and parameters, transmits from the operator task component 3102 to the simulation orchestrator component 412. At time t7, the simulation orchestrator component 412 performs digital twin simulations for a given objective. The simulation orchestrator component 412 may perform multiple iterations of simulations and data analytics. At time t8, an activate recipe response, including a recommended configuration and/or layout, transmits from the simulation orchestrator component 412 to the operator task component 3102.

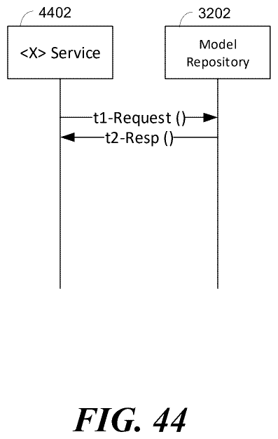

FIG. 44 is a timing diagram illustrating a repository access technique, in accordance with aspects of the present disclosure. At time t1, a service component 4402 transmits a request to the model repository 3202. The service component 4402 may generally represent any one RAN service. At time t2, a response transmits from the model repository 3202 to the service component 4402. The model repository 3202 may store 3D models, radio models, network models, UE models, traffic models, RAN models, antenna models, TRU placement models, device placement models, mobility models, UE configuration models, network configuration models, user activity models, network usage models, device capability models, and density models.

As indicated above, FIGS. 3-44 are provided as examples. Other examples may differ from what is described with respect to FIGS. 3-44.

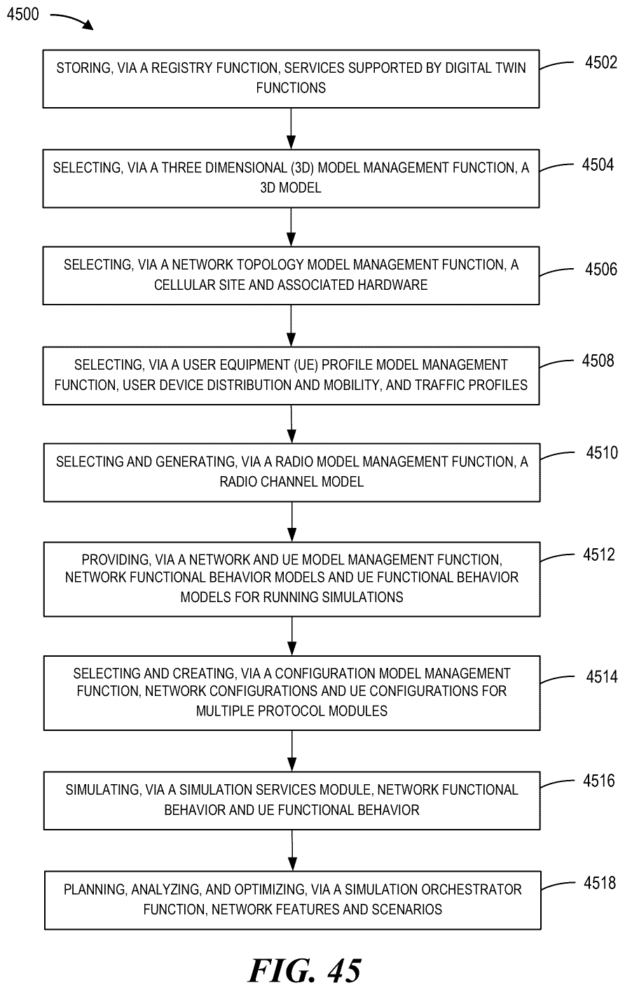

FIG. 45 is a flow diagram illustrating an example process 4500 performed, for example, by a network device, in accordance with various aspects of the present disclosure. The example process 4500 is an example of a technique for implementing a digital twin. In some aspects, the process 4500 may include storing, via a registry function, services supported by digital twin functions (block 4502). The registry function may include, for example, the registry component 402. As discussed, the registry function may store 3D models, radio models, network models, user equipment (UE) models, traffic models, RAN models, antenna models, transmit/receive unit (TRU) placement models, device placement models, mobility models, UE configuration models, network configuration models, user activity models, network usage models, device capability models, and density models.

The process 4500 may also include selecting, via a 3D model management function, a 3D model (block 4504). The 3D model management function may include the 3D model management component 404. As discussed, the 3D model management function may be configured to maintain 3D models of structures such as cities, towns, and marketplaces. The 3D models maintained by the 3D model management function may be physical world to digital world models including object and material tagging. The 3D model management function may also extract a 3D model of a region of interest from available city or town level models.

The process 4500 may also include selecting, via a network topology model management function, a cellular site and associated hardware (block 4506). The network topology model management function may include the network topology management component 406. As discussed, the network topology model management function may provide services for selecting cellular sites and hardware, and may also be configured to maintain TRU placement models of structures in cities, towns, and marketplaces, where the placement models may be based on physical world locations of base stations. Additionally, the network topology model management function may create a layout model of a TRU or TRUs within the geographical region of interest considered for simulation study.

The process 4500 may also include selecting, via a UE profile model management function, user device distribution and mobility, and traffic profiles (block 4508). The UE profile model management function may include the UE profile model management component 408 and may provide services for selecting user device distribution, user device mobility, and traffic profiles. The UE profile model management function may also be configured to maintain receiver placement models of structures such as cities, towns, and marketplaces, where the placement models may be based on physical world locations of UEs. Further, the UE profile model management function may be implemented to create a layout model of one or more UEs within a geographical region of interest considered for simulation study.

The process 4500 may also include selecting and generating, via a radio model management function, a radio channel model (block 4510). The radio model management function may include the radio model management component 410 and may provide services for selecting and generating a radio channel model. The radio model management function may also be configured to provide radio modeling services for generating radio models for a given scenario or 3D model. Additionally, the radio model management function may perform stochastic modeling, ray-tracing based deterministic modeling, artificial intelligence (AI) and/or machine learning (ML) based modeling, or any other method of generating radio models. Once generated for a geographical region, radio models may be stored and/or maintained via a model repository service.

The process 4500 may also include providing, via a network and UE model management function, network functional behavior models and UE functional behavior models for running simulations (block 4512). The network and UE model management function may include the network and UE model management component 414 and may provide services for network and UE function behavior models. Additionally, the network and UE model management function may be configured to provide network and user device behavior model services for processing simulations. The models produced or maintained by the network and UE model management function may be defined in any conventional format such as any combination of emulator and/or simulator binaries, object code, and AI and/or ML models.

The process 4500 may also include selecting and creating, via a configuration model management function, network configurations and UE configurations for multiple protocol modules (block 4514). The configuration model management function may include the configuration management component 416 and may provide services for selecting and creating network and UE configurations for various protocol modules. Additionally, the configuration model management function may be configured to maintain network and UE configuration models corresponding to either existing configurations of a physical world RAN or proposed configurations for new features and/or services that are simulated via the digital twin. The UE configuration models may have different protocol layer parameter configurations.

The process 4500 may also include simulating, via a simulation services module, network functional behavior and UE functional behavior (block 4516). The simulation services module may include the simulation services component 418 and may provide services for simulating network and UE functional behavior. The simulation services module may also be configured to provide simulation services for performing end-to-end simulations and receiving input such as radio, network, UE, or traffic models and scenario configurations. Additionally, the simulation services module may be implemented by the simulation orchestrator component 412 for specified scenarios and configurations.

The process 4500 may also include planning, analyzing, and optimizing, via a simulation orchestrator function, network features and scenarios (block 4518). The simulation orchestrator function may include the simulation orchestrator component 412. Additionally, the simulation orchestrator function may be configured to maintain recipes for analysis and improvement of different network features, behaviors, and performances. The simulation orchestrator function may take, as input, intent or use-case and a network or geographical region and may manage end-to-end scenario simulation and improvement. To manage end-to-end scenario simulation and improvement, the simulation orchestrator function may perform model selection, data collection, simulation and/or emulation, analytics on simulation output, defining iterations specified for meeting the objective of an intent or use-case, and generating recommended configuration and placement of network elements.

### Example Aspects

Aspect 1: An apparatus including a digital twin of a wireless network, the digital twin comprising: a registry function configured to store services supported by digital twin functions; a three-dimensional (3D) model management function configured to provide services for selecting a 3D model; a network topology model management function configured to provide services for selecting a cellular site and associated hardware; a user equipment (UE) profile model management function configured to provide services for selecting user device distribution and mobility, and traffic profiles; a radio model management function configured to provide services for selecting and generating a radio channel model; a network and UE model management function configured to provide services for providing network functional behavior models and UE functional behavior models for running simulations; a configuration model management function configured to provide services for selecting and creating network configurations and UE configurations for a plurality of protocol modules; a simulation services module configured to provide services for simulating network functional behavior and UE functional behavior; and a simulation orchestrator function configured to provide services for planning, analyzing, and optimizing network features and scenarios.

Aspect 2: The apparatus of Aspect 1, in which the apparatus comprises an open radio access network (O-RAN) service management and orchestration platform (SMO).

Aspect 3: The apparatus of Aspect 1 or 2, in which the apparatus comprises a non-real-time radio access network intelligent controller application (rApp).

Aspect 4: The apparatus of any of the Aspects 1-3, in which an open radio access network (O-RAN) service management and exposure platform registers discoverable services of the digital twin.

Aspect 5: The apparatus of any of the Aspects 1-4, in which an open radio access network (O-RAN) topology exposure and inventory management platform generates cellular site location layouts and types of hardware resources installed for the digital twin.

Aspect 6: The apparatus of any of the Aspects 1-5, in which an open radio access network (O-RAN) network function configuration manager component (NF CM) generates network configurations for the digital twin from a plurality of stored configurations.

Aspect 7: The apparatus of any of the Aspects 1-6, in which an open radio access network (O-RAN) network function performance manager component provides performance reports, trace logs, and user device location information.

Aspect 8: The apparatus of any of the Aspects 1-7, in which an open radio access network (O-RAN) network function fault manager component provides notifications to registered digital twin subscribers in response to faults or monitored fire alarms.

Aspect 9: The apparatus of any of the Aspects 1-8, in which an open radio access network (O-RAN) service management and orchestration (SMO) intent manager provides intent as input to the digital twin.

Aspect 10: The apparatus of any of the Aspects 1-9, in which an artificial intelligence/machine learning (AI/ML) workflow service of an open radio access network (O-RAN) service management and orchestration (SMO) module stores models of the digital twin.

Aspect 11: A method for implementing a digital twin of a wireless network, comprising: storing, via a registry function, services supported by digital twin functions; selecting, via a three dimensional (3D) model management function, a 3D model; selecting, via a network topology model management function, a cellular site and associated hardware; selecting, via a user equipment (UE) profile model management function, user device distribution and mobility, and traffic profiles; selecting and generating, via a radio model management function, a radio channel model; providing, via a network and UE model management function, network functional behavior models and UE functional behavior models for running simulations; selecting and creating, via a configuration model management function, network configurations and UE configurations for a plurality of protocol modules; simulating, via a simulation services module, network functional behavior and UE functional behavior; and planning, analyzing, and optimizing, via a simulation orchestrator function, network features and scenarios.

Aspect 12: The method of Aspect 11, further comprising registering, via an open radio access network (O-RAN) service management and exposure platform, discoverable services of the digital twin.

Aspect 13: The method of Aspect 11 or 12, further comprising generating cellular site location layouts and types of hardware resources installed for the digital twin via an open radio access network (O-RAN) topology exposure and inventory management platform.

Aspect 14: The method of any of the Aspects 11-13, further comprising generating, via an open radio access network (O-RAN) network function configuration manager component (NF CM), network configurations for the digital twin from a plurality of stored configurations.

Aspect 15: The method of any of the Aspects 11-14, further comprising transmitting, via an open radio access network (O-RAN) network function performance manager component performance reports, trace logs, and user device location information.

Aspect 16: The method of any of the Aspects 11-15, further comprising transmitting, via an open radio access network (O-RAN) network function fault manager component, notifications to registered digital twin subscribers in response to faults or monitored fire alarms.

Aspect 17: The method of any of the Aspects 11-16, further comprising inputting intent to the digital twin, via an open radio access network (O-RAN) service management and orchestration (SMO) intent manager.

Aspect 18: The method of any of the Aspects 11-17, further comprising storing, via an artificial intelligence/machine learning (AI/ML) workflow service of an open radio access network (O-RAN) service management and orchestration (SMO) module, models of the digital twin.

Aspect 19: A non-transitory computer-readable medium having program code recorded thereon for implementing a digital twin of a wireless network, comprising: program code to store, via a registry function, services supported by digital twin functions; program code to select, via a three dimensional (3D) model management function, a 3D model; program code to select, via a network topology model management function, a cellular site and associated hardware; program code to select, via a user equipment (UE) profile model management function, user device distribution and mobility, and traffic profiles; program code to select and generate, via a radio model management function, a radio channel model; program code to provide, via a network and UE model management function, network functional behavior models and UE functional behavior models for running simulations; program code to select and create, via a configuration model management function, network configurations and UE configurations for a plurality of protocol modules; program code to simulate, via a simulation services module, network functional behavior and UE functional behavior; and program code to plan, analyze, and optimize, via a simulation orchestrator function, network features and scenarios.

Aspect 20: The non-transitory computer-readable medium of Aspect 19, in which the program code further includes program code to register, via an open radio access network (O-RAN) service management and exposure platform, discoverable services of the digital twin.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code-it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus including a digital twin of a wireless network, the digital twin comprising:
a registry function configured to store services supported by digital twin functions;
a three-dimensional (3D) model management function configured to provide services for selecting a 3D model;
a network topology model management function configured to provide services for selecting a cellular site and associated hardware;
a user equipment (UE) profile model management function configured to provide services for selecting user device distribution and mobility, and traffic profiles;
a radio model management function configured to provide services for selecting and generating a radio channel model;
a network and UE model management function configured to provide network functional behavior models and UE functional behavior models for running simulations;
a configuration model management function configured to provide services for selecting and creating network configurations and UE configurations for a plurality of protocol modules;
a simulation services module configured to provide services for simulating network functional behavior and UE functional behavior; and
a simulation orchestrator function configured to provide services for planning, analyzing, and optimizing network features and scenarios.

2. The apparatus of claim 1, in which the apparatus comprises an open radio access network (O-RAN) service management and orchestration platform (SMO).

3. The apparatus of claim 1, in which the apparatus comprises a non-real-time radio access network intelligent controller application (rApp).

4. The apparatus of claim 1, in which an open radio access network (O-RAN) service management and exposure platform registers discoverable services of the digital twin.

5. The apparatus of claim 1, in which an open radio access network (O-RAN) topology exposure and inventory management platform generates cellular site location layouts and types of hardware resources installed for the digital twin.

6. The apparatus of claim 1, in which an open radio access network (O-RAN) network function configuration manager component (NF CM) generates network configurations for the digital twin from a plurality of stored configurations.

7. The apparatus of claim 1, in which an open radio access network (O-RAN) network function performance manager component provides performance reports, trace logs, and user device location information.

8. The apparatus of claim 1, in which an open radio access network (O-RAN) network function fault manager component provides notifications to registered digital twin subscribers in response to faults or monitored fire alarms.

9. The apparatus of claim 1, in which an open radio access network (O-RAN) service management and orchestration (SMO) intent manager provides intent as input to the digital twin.

10. The apparatus of claim 1, in which an artificial intelligence/machine learning (AI/ML) workflow service of an open radio access network (O-RAN) service management and orchestration (SMO) module stores models of the digital twin.

11. A method for implementing a digital twin of a wireless network, comprising:
storing, via a registry function, services supported by digital twin functions;
selecting, via a three dimensional (3D) model management function, a 3D model;
selecting, via a network topology model management function, a cellular site and associated hardware;
selecting, via a user equipment (UE) profile model management function, user device distribution and mobility, and traffic profiles;
selecting and generating, via a radio model management function, a radio channel model;
providing, via a network and UE model management function, network functional behavior models and UE functional behavior models for running simulations;
selecting and creating, via a configuration model management function, network configurations and UE configurations for a plurality of protocol modules;
simulating, via a simulation services module, network functional behavior and UE functional behavior; and
planning, analyzing, and optimizing, via a simulation orchestrator function, network features and scenarios.

12. The method of claim 11, further comprising registering, via an open radio access network (O-RAN) service management and exposure platform, discoverable services of the digital twin.

13. The method of claim 11, further comprising generating cellular site location layouts and types of hardware resources installed for the digital twin via an open radio access network (O-RAN) topology exposure and inventory management platform.

14. The method of claim 11, further comprising generating, via an open radio access network (O-RAN) network function configuration manager component (NF CM), network configurations for the digital twin from a plurality of stored configurations.

15. The method of claim 11, further comprising transmitting, via an open radio access network (O-RAN) network function performance manager component performance reports, trace logs, and user device location information.

16. The method of claim 11, further comprising transmitting, via an open radio access network (O-RAN) network function fault manager component, notifications to registered digital twin subscribers in response to faults or monitored fire alarms.

17. The method of claim 11, further comprising inputting intent to the digital twin, via an open radio access network (O-RAN) service management and orchestration (SMO) intent manager.

18. The method of claim 11, further comprising storing, via an artificial intelligence/machine learning (AI/ML) workflow service of an open radio access network (O-RAN) service management and orchestration (SMO) module, models of the digital twin.

19. A non-transitory computer-readable medium having program code recorded thereon for implementing a digital twin of a wireless network, comprising:
program code to store, via a registry function, services supported by digital twin functions;
program code to select, via a three dimensional (3D) model management function, a 3D model;
program code to select, via a network topology model management function, a cellular site and associated hardware;
program code to select, via a user equipment (UE) profile model management function, user device distribution and mobility, and traffic profiles;
program code to select and generate, via a radio model management function, a radio channel model;
program code to provide, via a network and UE model management function, network functional behavior models and UE functional behavior models for running simulations;
program code to select and create, via a configuration model management function, network configurations and UE configurations for a plurality of protocol modules;
program code to simulate, via a simulation services module, network functional behavior and UE functional behavior; and
program code to plan, analyze, and optimize, via a simulation orchestrator function, network features and scenarios.

20. The non-transitory computer-readable medium of claim 19, in which the program code further includes program code to register, via an open radio access network (O-RAN) service management and exposure platform, discoverable services of the digital twin.
